(19) United States
(12) Patent Application Publication
(10) Pub. No.: US 2026/0330415 A1
(43) Pub. Date: Oct. 22, 2026

(54) SYSTEMS, APPARATUSES, METHODS, AND COMPUTER PROGRAM PRODUCTS FOR AUTOMATED PROJECT OPERATIONS ARCHITECTURE

(71) Applicant: HONEYWELL INTERNATIONAL INC., Charlotte, NC (US)

(72) Inventors: Anil PALLAYIL, Charlotte, NC (US); Rahul SHARMA, Houston, TX (US); Honey RAGHAVAN, Bangalore (IN)

(21) Appl. No.: 19/650,809

(22) Filed: Apr. 17, 2026

Related U.S. Application Data
(60) Provisional application No. 63/790,880, filed on Apr. 18, 2025.

(51) Int. Cl. G06Q 10/10; G06F 16/93

(52) U.S. Cl. CPC G06Q 10/103; G06F 16/93

(57) ABSTRACT

Systems, apparatuses, methods, and computer program products are provided herein. For example, a method may include accessing, at a project orchestration predictive computing entity, a requirement electronic record. In some embodiments, the requirement electronic record comprises a requirement feature. In some embodiments, the requirement electronic record is generated based on a requirement electronic record generation operation. In some embodiments, the method comprises generating, using a project record predictive computing entity, a project electronic record based on the requirement electronic record and by performing at least one of a set of project electronic record generation operations. In some embodiments, the method comprises performing, using the project orchestration predictive computing entity, a project configuration check operation on the project electronic record. In some embodiments, the method comprises performing, using the project orchestration predictive computing entity, one or more project responsive actions based on the project electronic record.

This application claims priority U.S. Provisional Application No. 63/790,880, titled SYSTEMS, APPARATUSES, METHODS, AND COMPUTER PROGRAM PRODUCTS FOR AUTOMATED PROJECT OPERATIONS ARCHITECTURE, filed Apr. 18, 2025, which is hereby incorporated by reference in its entirety.

### TECHNOLOGICAL FIELD

Embodiments of the present disclosure relate generally to systems, apparatuses, methods, and computer program products for automated project operations architecture.

### BACKGROUND

Applicant has identified many technical challenges and difficulties associated with systems, apparatuses, methods, and computer program products for automated project operations. Through applied effort, ingenuity, and innovation, Applicant has solved problems related to systems, apparatuses, methods, and computer program products for automated project operations by developing solutions embodied in the present disclosure, which are described in detail below.

### BRIEF SUMMARY

Various embodiments described herein relate to systems, apparatuses, methods, and computer program products for automated project operations.

In accordance with one aspect of the disclosure a method is provided. In some embodiments, the method comprises accessing, at a project orchestration predictive computing entity, a requirement electronic record. In some embodiments, the requirement electronic record comprises a requirement feature. In some embodiments, the requirement electronic record is generated based on a requirement electronic record generation operation. In some embodiments, the method comprises generating, using a project record predictive computing entity, a project electronic record based on the requirement electronic record and by performing at least one of a set of project electronic record generation operations. In some embodiments, the method comprises performing, using the project orchestration predictive computing entity, a project configuration check operation on the project electronic record. In some embodiments, the method comprises performing, using the project orchestration predictive computing entity, one or more project responsive actions based on the project electronic record.

In some embodiments, the requirement electronic record generation operation comprises receiving one or more requirement features associated with a project. In some embodiments, the requirement electronic record generation operation comprises identifying a first requirement feature of the one or more requirement features associated with the project. In some embodiments, the requirement electronic record generation operation comprises generating an inferred requirements interface component comprising one or more prompts corresponding to a responsive feature associated with the first requirement feature. In some embodiments, the requirement electronic record generation operation comprises causing the inferred requirements interface component to be rendered to a project operations interface. In some embodiments, the requirement electronic record generation operation comprises receiving the responsive feature associated with the first requirement feature via the inferred requirements interface component. In some embodiments, the requirement electronic record generation operation comprises updating the first requirement feature based on the responsive feature. In some embodiments, the requirement electronic record generation operation comprises generating the requirement electronic record based on at least the first requirement feature.

In some embodiments, a first project electronic record generation operation of the set of project electronic record generation operations comprises identifying an archived project electronic record by performing at least one electronic filtering operation of a set of electronic filtering operations. In some embodiments, the archived project electronic record is representative of an archived physical component corresponding to the requirement feature. In some embodiments, a first project electronic record generation operation of the set of project electronic record generation operations comprises generating an archived physical component clone based on the archived physical component. In some embodiments, a first project electronic record generation operation of the set of project electronic record generation operations comprises generating a physical component object by configuring the archived physical component clone based on the requirement electronic record. In some embodiments, a first project electronic record generation operation of the set of project electronic record generation operations comprises generating the project electronic record based on the physical component object.

In some embodiments, the set of electronic filtering operations comprises a text-based filtering operation, geometry-based filtering operation, design-based filtering operation, sketch-based filtering operation, topology-based filtering operation, or color-based filtering operation.

In some embodiments, a second project electronic record generation operation of the set of project electronic record generation operations comprises generating a responsive resource allocation unit by applying the requirement feature to a project implementation model. In some embodiments, a second project electronic record generation operation of the set of project electronic record generation operations comprises extracting a set of free resource unit objects from a plurality of resource unit objects based on the responsive resource allocation unit. In some embodiments, a second project electronic record generation operation of the set of project electronic record generation operations comprises generating a project electronic record by applying the set of free resource unit objects to the project implementation model.

In some embodiments, generating the responsive resource allocation unit comprises determining, using the project implementation model, a physical component object corresponding to the requirement feature. In some embodiments, generating the responsive resource allocation unit comprises determining, using the project implementation model, a physical component implementation unit based on the physical component object.

In some embodiments, a third project electronic record generation operation of the set of project electronic record generation operations comprises retrieving a set of archived physical component objects from an archived physical component database. In some embodiments, a third project electronic record generation operation of the set of project electronic record generation operations comprises generating a physical component requirement indication by applying the requirement electronic record and the set of archived physical component objects to a component differentiation model. In some embodiments, physical component requirement indication comprises a physical component generation indicator or a physical component reconfiguration indicator. In some embodiments, a third project electronic record generation operation of the set of project electronic record generation operations comprises generating a new physical component object based on the physical component generation indicator or generating a reconfigured physical component object based on the physical component reconfiguration indicator. In some embodiments, a third project electronic record generation operation of the set of project electronic record generation operations comprises generating the project electronic record based on the new physical component object or the reconfigured physical component object.

In some embodiments, the project electronic record comprises a physical component object and a physical component implementation unit. In some embodiments, performing a project configuration check operation comprises generating a project configuration check interface component. In some embodiments, the project configuration check interface component comprises a physical component object representation corresponding to the physical component object or a physical component implementation unit representation corresponding to the physical component implementation unit. In some embodiments, performing a project configuration check operation comprises causing the project configuration check interface component to be rendered to a project operations interface. In some embodiments, performing a project configuration check operation comprises receiving a first reconfiguration feature corresponding to the physical component object via the project configuration check interface component or a second reconfiguration feature corresponding to the physical component implementation unit via the project configuration check interface component. In some embodiments, performing a project configuration check operation comprises updating the physical component object based on the first reconfiguration feature or the physical component implementation unit based on the second reconfiguration feature.

In some embodiments, performing one or more project responsive actions comprises generating a project electronic record interface component. In some embodiments, the project electronic record interface component comprises project electronic record interface element.

In some embodiments, performing one or more project responsive actions comprises causing rendering of the project electronic record interface component via a project operations interface. In some embodiments, performing one or more project responsive actions comprises causing a component inventory record to be updated.

In accordance with another aspect of the disclosure, an apparatus is provided. In some embodiments, the apparatus includes memory and one or more processors communicatively coupled to the memory. In some embodiments, the one or more processors are configured to perform operations comprising accessing, at a project orchestration predictive computing entity, a requirement electronic record. In some embodiments, the requirement electronic record comprises a requirement feature. In some embodiments, the requirement electronic record is generated based on a requirement electronic record generation operation. In In some embodiments, the one or more processors are configured to perform operations comprising generating, using a project record predictive computing entity, a project electronic record based on the requirement electronic record and by performing at least one of a set of project electronic record generation operations. In In some embodiments, the one or more processors are configured to perform operations comprising performing, using the project orchestration predictive computing entity, a project configuration check operation on the project electronic record. In In some embodiments, the one or more processors are configured to perform operations comprising performing, using the project orchestration predictive computing entity, one or more project responsive actions based on the project electronic record.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for accessing, at a project orchestration predictive computing entity, a requirement electronic record. In some embodiments, the requirement electronic record comprises a requirement feature. In some embodiments, the requirement electronic record is generated based on a requirement electronic record generation operation. In In some embodiments, the computer program code, in execution with at least one processor, configures the computer program product for generating, using a project record predictive computing entity, a project electronic record based on the requirement electronic record and by performing at least one of a set of project electronic record generation operations. In In some embodiments, the computer program code, in execution with at least one processor, configures the computer program product for performing, using the project orchestration predictive computing entity, a project configuration check operation on the project electronic record. In In some embodiments, the computer program code, in execution with at least one processor, configures the computer program product for performing, using the project orchestration predictive computing entity, one or more project responsive actions based on the project electronic record.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of the environment in which embodiments of the present disclosure may operate;

FIG. 3 illustrates an example block diagram of an example apparatus that may be specially configured in accordance with an example embodiment of the present disclosure;

FIG. 4 illustrates an example interface component in accordance with an example embodiment of the present disclosure;

FIG. 5 illustrates an example interface component in accordance with an example embodiment of the present disclosure;

FIG. 6 illustrates an example interface component in accordance with an example embodiment of the present disclosure; and

FIG. 7 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for automated project operations. As would be understood by one skilled in the field to which this disclosure pertains, there are numerous example scenarios in which systems, apparatuses, methods, and computer program products for automated project operations are needed. For example, it may be desirable to use systems, apparatuses, methods, and computer program products for automated project operations to generate and/or configure a temperature control system for a building.

Example solutions for automated project operations include using computing devices to implement automated project operations. However, such example solutions are simplistic, inefficient, and reactive. For example, such example solutions are simplistic because such example solutions do not implement a plurality of predictive computing entities to execute discrete tasks using generative artificial intelligence to implement automated project operation. As another example, such example solutions are inefficient because such example solutions do not leverage a multiple project electronic generation techniques to facilitate automated project operations. As another example, such example solutions are reactive because such example solutions do not automatically implement project responsive actions based on generated project electronic records. Accordingly, there is a need for systems, apparatuses, methods, and computer program products that perform automated project operations in a sophisticated, efficient, and proactive manner.

Thus, to address these and/or other issues related to such example solutions, example systems, apparatuses, methods, and computer program products for new project generation are disclosed herein. For example, an embodiment in this disclosure, described in greater detail below, includes a method that includes accessing, at a project orchestration predictive computing entity, a requirement electronic record. In some embodiments, the requirement electronic record comprises a requirement feature. In some embodiments, the requirement electronic record is generated based on a requirement electronic record generation operation. In some embodiments, the method comprises generating, using a project record predictive computing entity, a project electronic record based on the requirement electronic record and by performing at least one of a set of project electronic record generation operations. In some embodiments, the method comprises performing, using the project orchestration predictive computing entity, a project configuration check operation on the project electronic record. In some embodiments, the method comprises performing, using the project orchestration predictive computing entity, one or more project responsive actions based on the project electronic record.

Further embodiments and advantages of the example systems, apparatuses, methods, and computer program products disclosed herein are described in the following co-pending U.S. patent applications: U.S. Application No. 63/790,876, titled “SYSTEMS, APPARATUSES, METHODS, AND COMPUTER PROGRAM PRODUCTS FOR AN INTERACTIVE PROJECT REQUIREMENTS ANALYSIS ENGINE”; U.S. Application No. 63/790,873, titled “SYSTEMS, APPARATUSES, METHODS, AND COMPUTER PROGRAM PRODUCTS FOR A PROJECT OUTCOME PREDICTIVE ENGINE”; U.S. Application No. 63/790,878, titled “SYSTEMS, APPARATUSES, METHODS, AND COMPUTER PROGRAM PRODUCTS FOR NEW PROJECT GENERATION”; U.S. Application No. 63/790,875, titled “SYSTEMS, APPARATUSES, METHODS, AND COMPUTER PROGRAM PRODUCTS FOR GENERATING A NEW PHYSICAL COMPONENT”; U.S. Application No. 63/790,882, titled “SYSTEMS, APPARATUSES, METHODS, AND COMPUTER PROGRAM PRODUCTS FOR REAL-TIME PROJECT INVENTORY OPTIMIZATION”; U.S. Application No. 63/790,885, titled “SYSTEMS, APPARATUSES, METHODS, AND COMPUTER PROGRAM PRODUCTS FOR REAL-TIME PROJECT SERVICES OPERATIONS”; U.S. Application No. 63/790,889, titled “SYSTEMS, APPARATUSES, METHODS, AND COMPUTER PROGRAM PRODUCTS FOR PROJECT PROGRAM GENERATION”; U.S. Application No. 63/790,892, titled “SYSTEMS, APPARATUSES, METHODS, AND COMPUTER PROGRAM PRODUCTS FOR AUTOMATED PROJECT QUALITY CONTROL”; U.S. Application No. 63/790,879, titled “SYSTEMS, APPARATUSES, METHODS, AND COMPUTER PROGRAM PRODUCTS FOR AI DRIVEN PROJECT COMPLIANCE FORECASTING”, each of which is filed concurrently with the present application. The contents of each of the foregoing applications are hereby incorporated by reference in their entirety.

### Example Systems and Apparatuses

Embodiments of the present disclosure herein include systems, apparatuses, methods, and computer program products configured for automated project operations. It should be readily appreciated that the embodiments of the apparatus, systems, methods, and computer program product described herein may be configured in various additional and alternative manners in addition to those expressly described herein.

Additionally, or alternatively, in some embodiments, the cloud-based project operations device 140 is configured via hardware, software, firmware, and/or a combination thereof, to generate and/or transmit command(s) that control, adjust, or otherwise impact operations of one or more of the project foundation device 180, the external project implementation device 120, the external project application device 110, the one or more databases 150, and/or the user device 170. Additionally, or alternatively, in some embodiments, the cloud-based project operations device 140 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the external project application device 110, the one or more databases 150, and/or the user device 170. For example, in various embodiments, the cloud-based project operations device 140 may be configured to execute and/or perform one or more operations and/or functions described herein.

In some embodiments, the environment 100 comprises the external project implementation device 120. In some embodiments, the external project implementation device 120 is electronically and/or communicatively coupled to the project foundation device 180, the external project application device 110, the cloud-based project operations device 140, the one or more databases 150, and/or the user device 170. The external project implementation device 120 may be located remotely from the project foundation device 180, the external project application device 110, the cloud-based project operations device 140, the one or more databases 150, and/or the user device 170. In this regard, for example, the external project implementation device 120 may be located in a remote cloud server and electronically and/or communicatively coupled to the project foundation device 180, the external project application device 110, the cloud-based project operations device 140, the one or more databases 150, and/or the user device 170 via at least the network 130. In some embodiments, the external project implementation device 120 is configured via hardware, software, firmware, and/or a combination thereof, to perform data intake of one or more types of data.

Additionally, or alternatively, in some embodiments, the external project implementation device 120 is configured via hardware, software, firmware, and/or a combination thereof, to generate and/or transmit command(s) that control, adjust, or otherwise impact operations of one or more of the project foundation device 180, the external project application device 110, the cloud-based project operations device 140, the one or more databases 150, and/or the user device 170. Additionally, or alternatively, in some embodiments, the external project implementation device 120 is configured via hardware, software, firmware, and/or a combination thereof, to perform data reporting, provide data, and/or other data output process(es) associated with monitoring or otherwise analyzing operations of one or more of the project foundation device 180, the external project application device 110, the cloud-based project operations device 140, the one or more databases 150, and/or the user device 170. For example, in various embodiments, the external project implementation device 120 may be configured to execute and/or perform one or more operations and/or functions described herein.

In some embodiments, the environment 100 comprises an external project application device 110. In some embodiments, the external project application device 110 is electronically and/or communicatively coupled to the project foundation device 180, the external project implementation device 120, the cloud-based project operations device 140, the one or more databases 150, and/or the user device 170. The external project application device 110 may be located remotely from the project foundation device 180, the external project implementation device 120, the cloud-based project operations device 140, the one or more databases 150, and/or the user device 170. In this regard, for example, the external project application device 110 may be located in a remote cloud server and electronically and/or communicatively coupled to the project foundation device 180, the external project implementation device 120, the cloud-based project operations device 140, the one or more databases 150, and/or the user device 170 via at least the network 130. In some embodiments, the external project application device 110 is configured via hardware, software, firmware, and/or a combination thereof, to perform data intake of one or more types of data.

Additionally, or alternatively, in some embodiments, the external project application device 110 is configured via hardware, software, firmware, and/or a combination thereof, to generate and/or transmit command(s) that control, adjust, or otherwise impact operations of one or more of the project foundation device 180, the external project implementation device 120, the cloud-based project operations device 140, the one or more databases 150, and/or the user device 170. Additionally, or alternatively, in some embodiments, the external project application device 110 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the cloud-based project operations device 140, the one or more databases 150, and/or the user device 170. For example, in various embodiments, the external project application device 110 may be configured to execute and/or perform one or more operations and/or functions described herein.

In some embodiments, the environment 100 comprises the project foundation device 180. In some embodiments, the project foundation device 180 is electronically and/or communicatively coupled to the external project implementation device 120, the external project application device 110, the cloud-based project operations device 140, the one or more databases 150, and/or the user device 170. The project foundation device 180 may be located remotely from the external project implementation device 120, the external project application device 110, the cloud-based project operations device 140, the one or more databases 150, and/or the user device 170. In this regard, for example, the project foundation device 180 may be located in a remote cloud server and electronically and/or communicatively coupled to the external project implementation device 120, the external project application device 110, the cloud-based project operations device 140, the one or more databases 150, and/or the user device 170 via at least the network 130. In some embodiments, the project foundation device 180 is configured via hardware, software, firmware, and/or a combination thereof, to perform data intake of one or more types of data.

Additionally, or alternatively, in some embodiments, the project foundation device 180 is configured via hardware, software, firmware, and/or a combination thereof, to generate and/or transmit command(s) that control, adjust, or otherwise impact operations of one or more of the external project implementation device 120, the external project application device 110, the cloud-based project operations device 140, the one or more databases 150, and/or the user device 170. Additionally, or alternatively, in some embodiments, the project foundation device 180 is configured via hardware, software, firmware, and/or a combination thereof, to perform data reporting, provide data, and/or other data output process(es) associated with monitoring or otherwise analyzing operations of one or more of the external project implementation device 120, the external project application device 110, the cloud-based project operations device 140, the one or more databases 150, and/or the user device 170. For example, in various embodiments, the project foundation device 180 may be configured to execute and/or perform one or more operations and/or functions described herein.

The one or more databases 150 may be configured to receive, store, and/or transmit data. In some embodiments, the one or more databases 150 may be associated with data associated with the project foundation device 180, the external project implementation device 120, the external project application device 110, the cloud-based project operations device 140, and/or the user device 170. In some embodiments, the data may be received from the project foundation device 180, the external project implementation device 120, the external project application device 110, the cloud-based project operations device 140, and/or the user device 170. In some embodiments, the one or more databases 150 may be associated with data received from the project foundation device 180, the external project implementation device 120, the external project application device 110, the cloud-based project operations device 140, and/or the user device 170 in real-time. Additionally, or alternatively, the one or more databases 150 may be associated with data received from the project foundation device 180, the external project implementation device 120, the external project application device 110, the cloud-based project operations device 140, and/or the user device 170 on a periodic basis (e.g., the data may be received from the project foundation device 180, the external project implementation device 120, the external project application device 110, the cloud-based project operations device 140, the one or more databases 150, and/or the user device 170 once per day). Additionally, or alternatively, the one or more databases 150 may be associated with data received from the project foundation device 180, the external project implementation device 120, the external project application device 110, the cloud-based project operations device 140, and/or the user device 170 in response to a request for the data. Additionally, or alternatively, the one or more databases 150 may be associated with data inputted (e.g., by a user) into the project foundation device 180, the external project implementation device 120, the external project application device 110, the cloud-based project operations device 140, and/or the user device 170.

The user device 170 may be associated with users of the project foundation device 180, the external project implementation device 120, the external project application device 110, the cloud-based project operations device 140, and/or the one or more databases 150. In various embodiments, the project foundation device 180, the external project implementation device 120, the external project application device 110, the cloud-based project operations device 140, and/or the one or more databases 150 may generate and/or transmit a message, alert, or indication to a user via a user device 170. Additionally, or alternatively, a user device 170 may be utilized by a user to remotely access the project foundation device 180, the external project implementation device 120, the external project application device 110, the cloud-based project operations device 140, and/or the one or more databases 150. This may be by, for example, an application operating on the user device 170. A user may access the project foundation device 180, the external project implementation device 120, the external project application device 110, the cloud-based project operations device 140, and/or the one or more databases 150, remotely, including one or more visualizations, reports, and/or real-time displays.

In some embodiments, the project foundation device 180, the external project implementation device 120, the external project application device 110, the cloud-based project operations device 140, the one or more databases 150, and/or the user device 170 is associated with a determinable location. In some embodiments, the determinable location of the project foundation device 180, the external project implementation device 120, the external project application device 110, the cloud-based project operations device 140, the one or more databases 150, and/or the user device 170 represents an absolute position (e.g., GPS coordinates, latitude, and longitude locations, and/or the like) and/or a relative position (e.g., a point representation of the location of the project foundation device 180, the external project implementation device 120, the external project application device 110, the cloud-based project operations device 140, the one or more databases 150, and/or the user device 170 from a local origin point). In some embodiments, the project foundation device 180, the external project implementation device 120, the external project application device 110, the cloud-based project operations device 140, the one or more databases 150, and/or the user device 170 includes or otherwise is associated with a location sensor and/or software-driven location services that provide the location data representing the location corresponding to that the project foundation device 180, the external project implementation device 120, the external project application device 110, the cloud-based project operations device 140, the one or more databases 150, and/or the user device 170. In other embodiments the location of the project foundation device 180, the external project implementation device 120, the external project application device 110, the cloud-based project operations device 140, the one or more databases 150, and/or the user device 170 is stored and/or otherwise predetermined within a software environment, provided by a user and/or otherwise determinable to one or more systems.

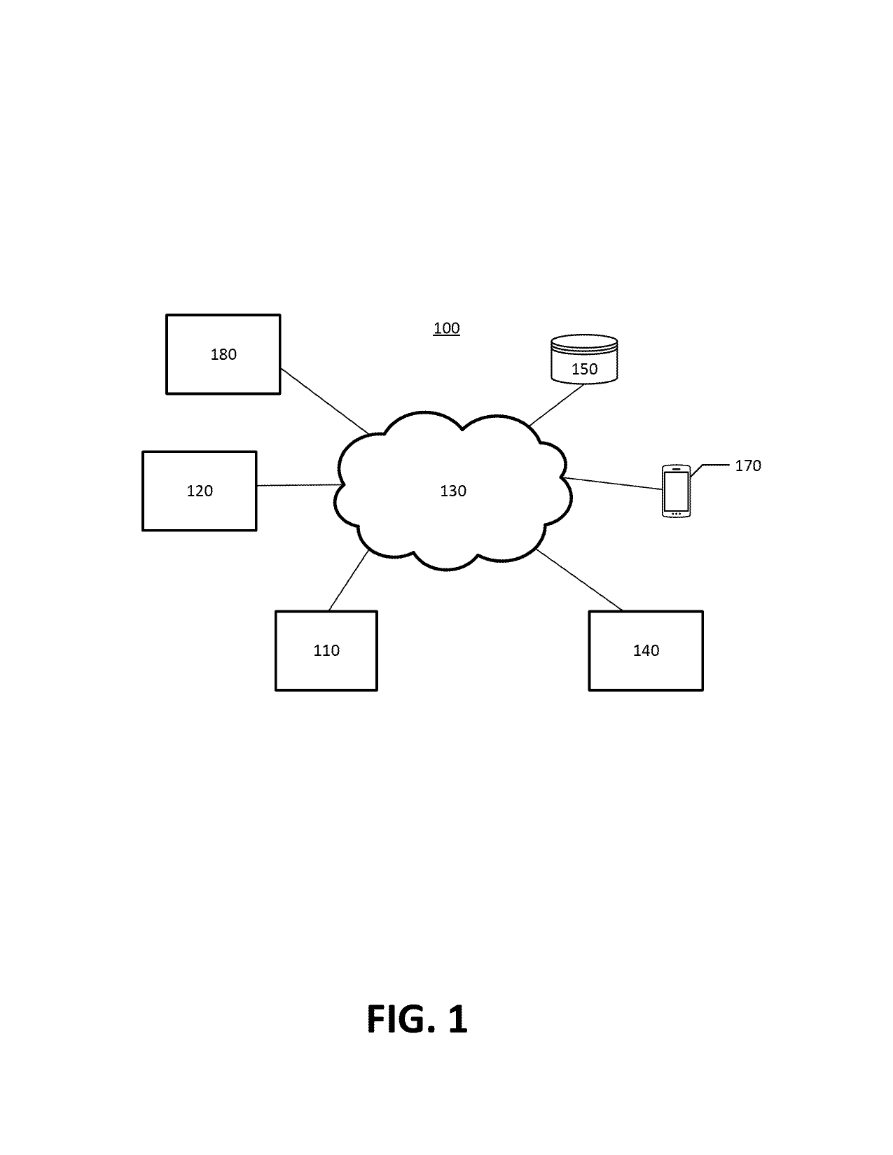

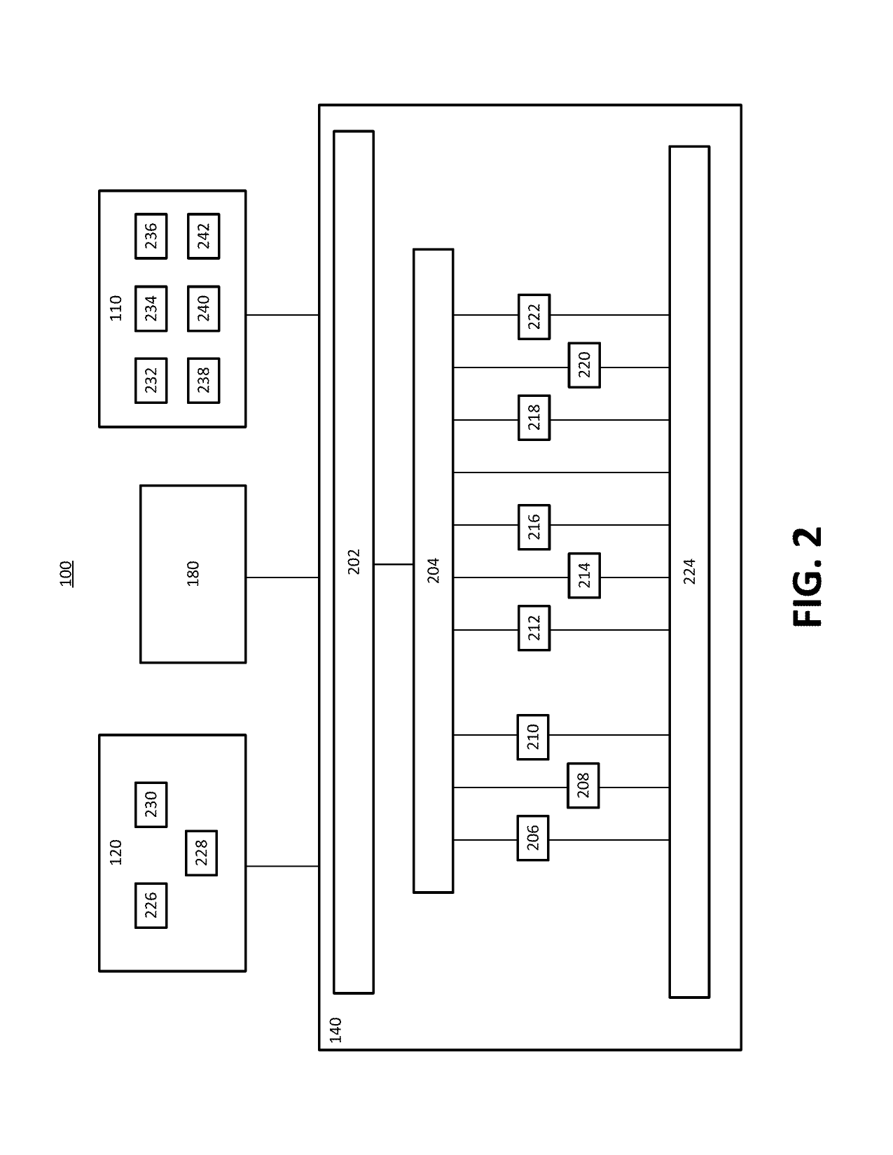

Additionally, while FIGS. 1 and 2 illustrate certain components as separate, standalone entities communicating over the network 130, various embodiments are not limited to this configuration. In other embodiments, one or more components may be directly connected and/or share hardware or the like.

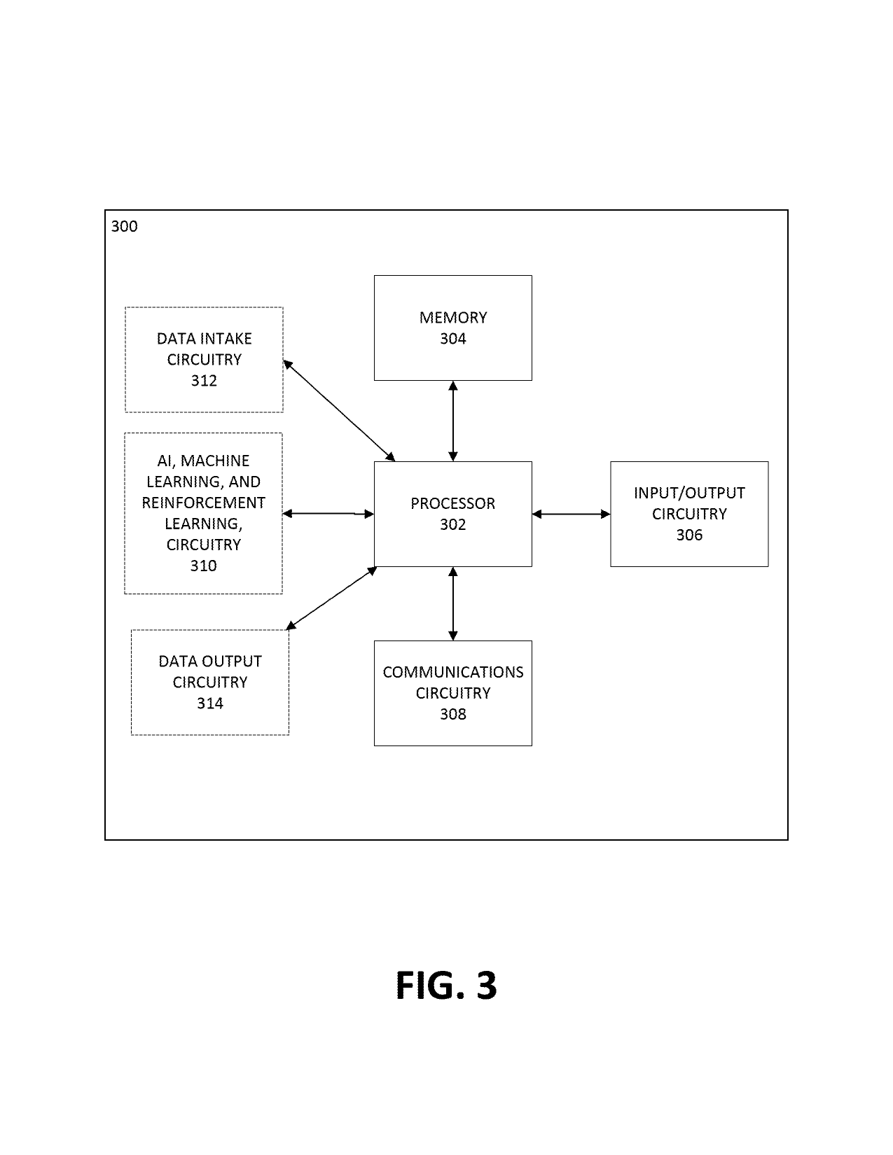

FIG. 3 illustrates an exemplary block diagram of an example apparatus that may be specially configured in accordance with an example embodiment of the present disclosure. Specifically, FIG. 3 depicts an example computing apparatus 300 (“apparatus 300”) specially configured in accordance with at least some example embodiments of the present disclosure. For example, the computing apparatus 300 may be embodied as one or more of a specifically configured personal computing apparatus, a specifically configured cloud-based computing apparatus, a specifically configured embedded computing device (e.g., configured for edge computing, and/or the like). Examples of an apparatus 300 may include, but is not limited to, the project foundation device 180, the external project implementation device 120, the external project application device 110, the cloud-based project operations device 140, the one or more databases 150, and/or the user device 170. The apparatus 300 includes processor 302, memory 304, input/output circuitry 306, communications circuitry 308, and/or optional artificial intelligence (“AI”) and machine learning circuitry 310. In some embodiments, the apparatus 300 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 300 of the project foundation device 180, the external project implementation device 120, the external project application device 110, the cloud-based project operations device 140, the one or more databases 150, and/or the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 300 embodies a particular, specially configured computing entity transformed to enable the specific operations described herein and provide the specific advantages associated therewith, as described herein.

Processor 302 or processor circuity 302 may be embodied in a number of different ways. In various embodiments, the use of the terms “processor” should be understood to include a single core processor, a multi-core processor, multiple processors internal to the apparatus 300, and/or one or more remote or “cloud” processor(s) external to the apparatus 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein.

In some embodiments, the processor 302 (and/or co-processor or any other processing circuitry assisting or otherwise associated with the processor) is/are in communication with the memory 304 via a bus for passing information among components of the apparatus 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling an apparatus 300 to carry out various operations and/or functions in accordance with example embodiments of the present disclosure.

Input/output circuitry 306 may be included in the apparatus 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the apparatus 300. The communications circuitry 308 may include any means such as a device or circuitry embodied in either hardware or a combination of hardware and software that is configured to receive and/or transmit data from/to a network and/or any other device, circuitry, or module in communication with the apparatus 300. In some embodiments the communications circuitry 308 includes, for example, a network interface for enabling communications with a wired or wireless communications network. Additionally, or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the apparatus 300.

Data intake circuitry 312 may be included in the apparatus 300. The data intake circuitry 312 may include hardware, software, firmware, and/or a combination thereof, designed and/or configured to capture, receive, request, and/or otherwise gather data associated with operations of the project foundation device 180, the external project implementation device 120, the external project application device 110, the cloud-based project operations device 140, the one or more databases 150, and/or the user device 170. In some embodiments, the data intake circuitry 312 includes hardware, software, firmware, and/or a combination thereof, that communicates with one or more sensor(s) unit(s), and/or the like within the project foundation device 180, the external project implementation device 120, the external project application device 110, the cloud-based project operations device 140, the one or more databases 150, and/or the user device 170 to receive particular data. Additionally, or alternatively, in some embodiments, the data intake circuitry 312 includes hardware, software, firmware, and/or a combination thereof, that retrieves particular data associated with the project foundation device 180, the external project implementation device 120, the external project application device 110, the cloud-based project operations device 140, the one or more databases 150, and/or the user device 170 from one or more data repository/repositories accessible to the apparatus 300.

AI and machine learning circuitry 310 may be included in the apparatus 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the apparatus 300. The data output circuitry 314 may include hardware, software, firmware, and/or a combination thereof, that configures and/or generates an output based at least in part on data processed by the apparatus 300. In some embodiments, the data output circuitry 314 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system sub-system for further processing. Additionally, or alternatively, in some embodiments, the data output circuitry 314 includes hardware, software, firmware, and/or a combination thereof, that causes rendering of a specially configured user interface based at least in part on data received by and/or processing by the apparatus 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

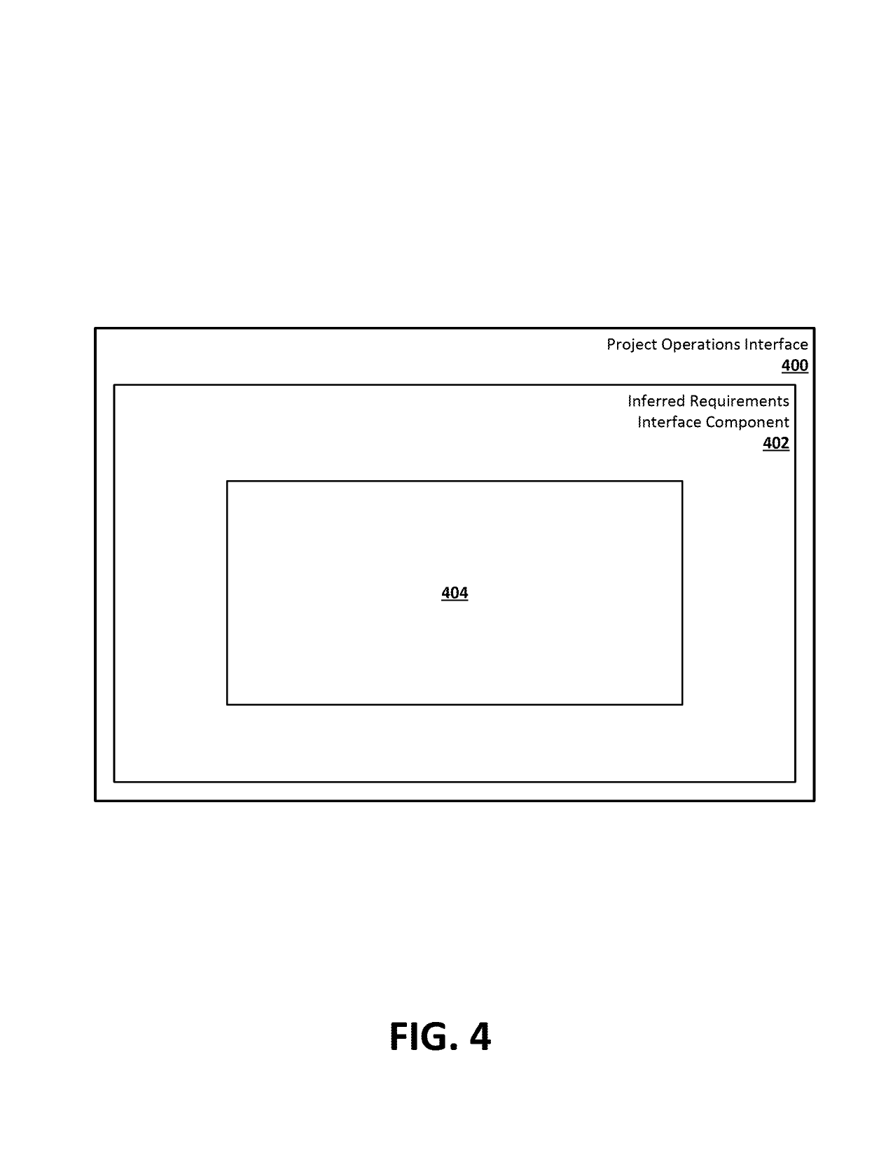

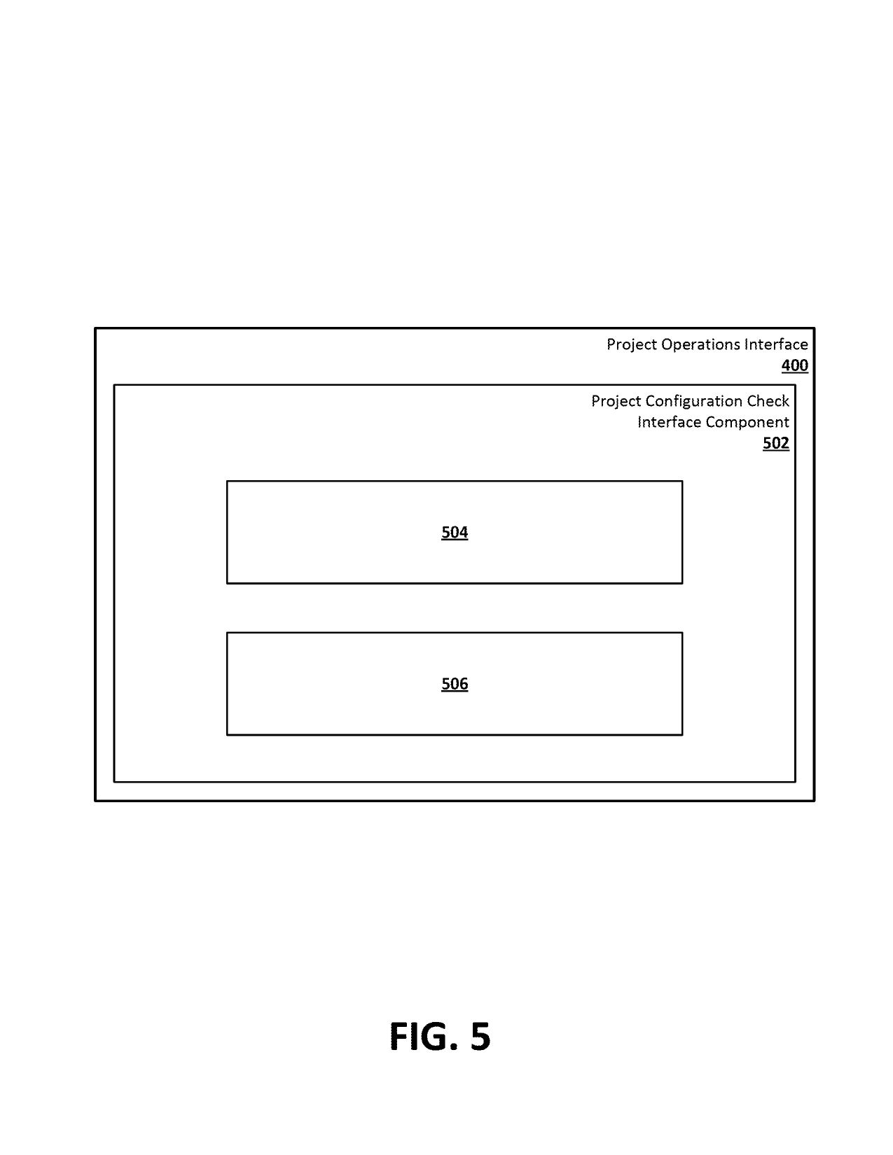

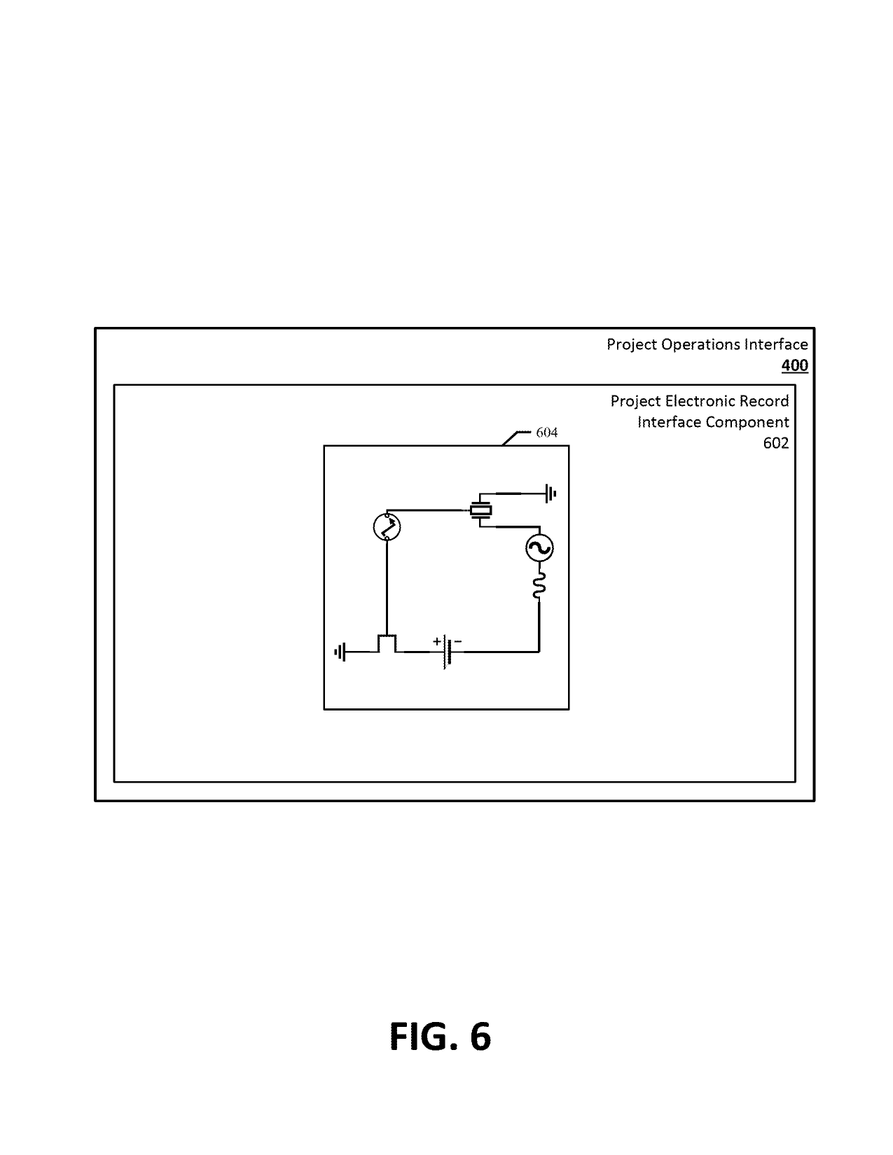

With reference to FIGS. 1-6, in some embodiments, a project may be a collection of components that may be implemented in a configured manner to accomplish one or more tasks. In this regard, for example, a project may be a collection of components that may be implemented in a configured manner in order to control the temperature of a building. For example, a project may be a collection of configured components that include temperature sensors, temperature control systems, circuits, and/or heating, ventilation, and air conditioning (HVAC) units that may be implemented in order to control the temperature of a building. In this regard, in some embodiments, a physical component may be any component configured to, in combination with other components, construct a configured component such as a temperature sensor, circuit, or HVAC unit.

In some embodiments, a physical component object comprises one or more items of data representative of a physical component that may be implemented in a project. For example, a physical component object may be representative of a temperature sensor, a circuit, an HVAC unit or any discrete, individual component used to construct a temperature sensor, a circuit, or an HVAC unit. Said differently, for example, a physical component object may be representative of a physical component that may form a portion of a project. In some embodiments, a physical component object may be referred to as a project component object.

In some embodiments, a project and/or a physical component object is associated with a physical component implementation unit. In some embodiments, a physical component implementation unit comprises one or more items of data representative of resources needed to design, engineer, test, implement, configure, and/or acquire one or more physical components associated with a project. In this regard, in some embodiments, a physical component implementation unit may comprise one or more items of data representative of one or more temporal resources, logistical resources, geographic resources, and/or implementation resources. In some embodiments, a temporal resource comprises an amount of time required to design, engineer, test, implement, configure, and/or acquire one or more physical components associated with a project. In some embodiments, a logistical resource comprises one or more external implementers (e.g., external software applications, external inventory providers, etc.) required to design, engineer, test, implement, configure, and/or acquire one or more physical components associated with a project. In some embodiments, a geographic resource comprises one or more locations (e.g., machines, factories, project sites, etc.) required to design, engineer, test, implement, configure, and/or acquire one or more physical components associated with a project. In some embodiments, an implementation resource comprises one or more engineers, designers, manufacturers, and/or the like required to design, engineer, test, implement, configure, and/or acquire one or more physical components associated with a project.

In some embodiments, the cloud-based project operations device 140 is configured to access a requirement electronic record. For example, the cloud-based project operations device 140 may be configured to access a requirement electronic record at the project orchestration predictive computing entity 204 (e.g., the cloud-based project operations device 140 is configured to access a requirement electronic record using the project orchestration predictive computing entity 204).

In some embodiments, a requirement electronic record comprises an electronic record that is representative of one or more requirement features (e.g., a requirement electronic record comprises one or more electronic records). In this regard, in some embodiments, a requirement electronic record may be one or more of a text document, a schematic drawing, a 3D model, a computer-aided design (CAD) file, an image, a video, and/or the like. For example, a requirement electronic record may be a schematic drawing that depicts one or more requirement features. As another example, a requirement electronic record may be a video that depicts one or more requirement features. As another example, a requirement electronic recordmay be a text document that describes one or more requirement features. As another example, a requirement electronic recordmay be a 3D model that depicts one or more requirement features. As another example, requirement electronic record may be a computer-aided design (CAD) file that describes and/or depicts one or more requirement features. As another example, requirement electronic record may be an image that depicts one or more requirement features.

In some embodiments, a requirement feature comprises one or more items of data representative of a requirement, a criteria, and/or a constraint that must be satisfied in order to implement a project (e.g., a proposed project that has not yet been implemented). For example, a requirement feature may be one or more items of data that are representative of a requirement, a criteria, and/or a constraint that must be satisfied in order to implement a project that includes controlling the temperature of a building. In this regard, for example, a requirement feature may be representative of a particular range in which the temperature of a building must be controlled to stay within (e.g., a requirement). As another example, a requirement feature may be representative of a physical layout of a building in which the temperature is to be controlled (e.g., a constraint). As another example, a requirement feature may be representative of an implementation time for a project (e.g., how long it may take to implement a project, when a project must be implemented, etc.). As another example, a requirement feature may be representative of a geographic location associated with a project (e.g., where a project should be implemented, a restriction on where resources for project should be obtained from, etc.).

In some embodiments, accessing a requirement electronic record comprises the cloud-based project operations device 140 being configured to retrieve a requirement electronic record. For example, the cloud-based project operations device 140 may be configured to retrieve a requirement electronic record from the one or more databases 150 using the project orchestration predictive computing entity 204. As another example, cloud-based project operations device 140 may be configured to retrieve a requirement electronic record from the internal databases 224 using the project orchestration predictive computing entity 204. In some embodiments, accessing a requirement electronic record comprises the cloud-based project operations device 140 being configured to receive a requirement electronic record. For example, the cloud-based project operations device 140 may be configured to receive a requirement electronic record from the project foundation device 180. As another example, the cloud-based project operations device 140 may be configured to receive a requirement electronic record from the external project application device 110. In some embodiments, prior to the cloud-based project operations device 140 accessing a requirement electronic record at the project orchestration predictive computing entity 204, a requirement electronic record may be processed by the project operations security layer 202 using one or more cybersecurity operations. In some embodiments, accessing a requirement electronic record comprises the cloud-based project operations device 140 providing access to a requirement electronic record to project operations predictive computing entity 220 via project orchestration predictive computing entity 204.

In some embodiments, accessing a requirement electronic record comprises the cloud-based project operations device 140 being configured to generate a requirement electronic record. In some embodiments, a requirement electronic record is generated based on a requirement electronic record generation operation. For example, a requirement electronic record generation operation may be performed using the project orchestration predictive computing entity 204. In this regard, in some embodiments, a requirement electronic record generation operation comprises the cloud-based project operations device 140 being configured to receive one or more requirement features associated with a project. For example, the cloud-based project operations device 140 may be configured to receive one or more requirement features associated with a project from the project foundation device 180. In some embodiments, the one or more requirement features may be received by the cloud-based project operations data in the form of project metadata from which the cloud-based project operations device 140 is configured to extract the one or more requirement features.

In some embodiments, a requirement electronic record generation operation comprises the cloud-based project operations device 140 being configured to identify a first requirement feature from the one or more requirement features associated with a project. In some embodiments, the cloud-based project operations device 140 is configured to identify a first requirement feature from the one or more requirement features based on a determination that the cloud-based project operations device 140 needs more information about the first requirement feature in order to generate a project electronic record. For example, if the first requirement feature is representative of a particular range in which the temperature of a building must be controlled to stay within (e.g., a requirement), the cloud-based project operations device 140 may determine that the project operations device 140 needs to determine what the particular range of temperature is in order to generate a project electronic record.

In some embodiments, a requirement electronic record generation operation comprises the cloud-based project operations device 140 being configured to generate an inferred requirements interface component 402. In some embodiments, the inferred requirements interface component 402 comprises one or more prompts. In some embodiments, the one or more prompts may be provided on the inferred requirements interface component 402 via a prompt window 404. In some embodiments, a prompt comprises a text string and/or text field indicating that more information about the first requirement feature that is needed by the cloud-based project operations device 140 in order to generate a project electronic record. For example, if the first requirement feature is representative of a particular range in which the temperature of a building must be controlled to stay within (e.g., a requirement), a prompt may comprise a text string and/or text field indicating that the cloud-based project operations device 140 needs the particular range of temperatures (e.g., 68 degrees to 72 degrees) in which the temperature of a building must be controlled to stay within. In some embodiments, a prompt corresponds to a responsive feature. In some embodiments, a responsive feature comprises a text string that is responsive to a prompt provided by the inferred requirements interface. In this regard, for example, if a prompt comprises a text string and/or text field indicating that the cloud-based project operations device 140 needs the particular range of temperatures (e.g., 68 degrees to 72 degrees) in which the temperature of a building must be controlled to stay within, a responsive feature may comprise a text string that provides the particular range of temperatures (e.g., 68 degrees to 72 degrees).

In some embodiments, a requirement electronic record generation operation comprises the cloud-based project operations device 140 being configured to cause the inferred requirements interface component 402 to be rendered to a project operations interface 400. For example, the project operations interface 400 may be provided on the project foundation device 180. In some embodiments, a requirement electronic record generation operation comprises the cloud-based project operations device 140 being configured to receive the responsive feature associated with the first requirement feature via the inferred requirements interface component 402. In this regard, in some embodiments, a user associated with the project foundation device 180 may be able to provide the responsive feature via the inferred requirements interface component 402.

In some embodiments, a requirement electronic record generation operation comprises the cloud-based project operations device 140 being configured to update the first requirement feature based on the responsive feature. For example, if the first requirement feature is representative of a particular range in which the temperature of a building must be controlled to stay within (e.g., a requirement) and the responsive feature comprises a text string that provides the particular range of temperatures (e.g., 68 degrees to 72 degrees), the cloud-based project operations device 140 may be updated to include data indicating the particular range of temperatures. In some embodiments, a requirement electronic record generation operation comprises the cloud-based project operations device 140 being configured to generate a requirement electronic record. For example, the cloud-based project operations device 140 may be configured to generate a requirement electronic record based on the first requirement feature.

In some embodiments, the cloud-based project operations device 140 is configured to generate a project electronic record. In some embodiments, a project electronic record comprises an electronic record that describes a plan, design, and/or process for implementing project corresponding to a requirement electronic record. In this regard, for example, a project electronic record may be representative of a collection of one or more physical component objects that may be used for implementing a project in accordance with a requirement electronic record. For example, a project electronic record may comprise a collection of physical component objects that are representative of temperature sensors, temperature control systems, circuits, and/or heating, ventilation, and air conditioning (HVAC) units that have been configured to control the temperature of a building based on one or more requirement features set forth in a requirement electronic record. In some embodiments, the cloud-based project operations device 140 is configured to generate a project electronic record using the project record predictive computing entity 212. Additionally, or alternatively, a project electronic record may be representative of a collection of one or more physical component implementation units that are associated with a project associated with the project electronic record. For example, a project electronic record may comprise one or more items of data representative of one or more resources (e.g., temporal resources, logistical resources, geographic resources, and/or implementation resources) needed to design, engineer, test, implement, configure, and/or acquire one or more physical components that are associated with a project associated with the project electronic record. Said differently, for example, a project electronic record may comprise one or more items of data representative of one or more resources that could potentially be used by the cloud-based project operations device 140 to implement a physical component in a project associated with a project electronic record.

In some embodiments, the cloud-based project operations device 140 is configured to generate a project electronic record based on a requirement electronic record and/or by performing at least one of a set of project electronic record generation operations. In this regard, in some embodiments, the set of project electronic record generation operations may comprise a collection of project electronic record generation operations that may be performed in order to generate various portions of a project electronic record based on various different constraints associated with a particular project (e.g., a proposed project) and/or the cloud-based project operations device 140.

In some embodiments, the set of project electronic record generation operations comprises a first project electronic record generation operation. In some embodiments, the first project electronic record generation operation is performed in order to generate a physical component object for a project electronic record based on an archived project electronic record. In this regard, in some embodiments, the first project electronic record generation operation comprises the cloud-based project operations device 140 being configured to identify an archived project electronic record. In some embodiments, an archived project electronic record comprises an electronic record that describes a completed, previous, and/or archived project. In this regard, in some embodiments, an archived project electronic record is representative of a collection of archived physical components that were implemented in the completed, previous, and/or archived project associated with the archived project electronic record. For example, an archived project electronic record may be representative of a collection of archived physical components that include temperature sensors, temperature control systems, circuits, and/or heating, ventilation, and air conditioning (HVAC) units that have been configured to control the temperature of a building. Said differently, for example, an archived project electronic record may be representative of an archived physical components that formed a portion of a completed, previous, and/or archived project. In some embodiments, an archived project electronic record is representative of an archived physical component corresponding to a requirement feature.

In some embodiments, the cloud-based project operations device 140 is configured to identify an archived project electronic record using the project record predictive computing entity 212. In some embodiments, the cloud-based project operations device 140, using the project record predictive computing entity 212, is configured to identify an archived project electronic record by performing at least one electronic filtering operation of a set of electronic filtering operations. In some embodiments, the cloud-based project operations device 140, using the project record predictive computing entity 212, is configured to identify an archived project electronic record based on a requirement electronic record. In this regard, in some embodiments, the cloud-based project operations device 140, using the project record predictive computing entity 212, is configured to perform one or more of the set of electronic filtering operations based on a requirement electronic record.

In some embodiments, the set of electronic filtering operations comprises a text-based filtering operation. In some embodiments, a text-based filtering operation comprises identifying a first sequence of characters from a requirement electronic record using an optical character recognition (OCR) technique. In some embodiments, a text-based filtering operation comprises identifying one or more other sequences of characters from one or more archived project electronic records using an optical character recognition (OCR) technique. In some embodiments, a text-based filtering operation comprises comparing the first sequence of characters with one or more of the one or more other sequences of characters. In this regard, for example, the cloud-based project operations device 140 may identify an archived project electronic record by finding a match between the first sequence of characters and the one or more of the one or more other sequences of characters. In some embodiments, the cloud-based project operations device 140 may leverage the project extraction predictive computing entity 226 to execute an optical character recognition (OCR) technique (e.g., the project extraction predictive computing entity 226 may be configured to perform an optical character recognition (OCR) technique).

In some embodiments, the set of electronic filtering operations comprises a geometry-based filtering operation. In some embodiments, a geometry-based filtering operation comprises identifying a geometric element from a requirement electronic record. In some embodiments, a geometry-based filtering operation comprises identifying one or more other geometric elements from one or more archived project electronic records. In some embodiments, a geometry-based filtering operation comprises comparing the geometric element with one or more of the one or more other geometric elements. In this regard, for example, the cloud-based project operations device 140 may identify an archived project electronic record by finding a match between the geometric element and the one or more of the one or more other geometric elements.

In some embodiments, the set of electronic filtering operations comprises a design-based filtering operation. In some embodiments, a design-based filtering operation comprises identifying a data encoding from a requirement electronic record. For example, a data encoding may comprise one or more of an svg, .dwg, .tiff, .png, .obj, .amf, .stl, and/or .glb data encoding. In some embodiments, a design-based filtering operation comprises identifying one or more other data encodings from one or more archived project electronic records. In some embodiments, a design-based filtering operation comprises comparing the data encoding with one or more of the one or more other data encodings. In this regard, for example, the cloud-based project operations device 140 may identify an archived project electronic record by finding a match between the data encoding and the one or more of the one or more other data encodings.

In some embodiments, the set of electronic filtering operations comprises a sketch-based filtering operation. In some embodiments, a sketch-based filtering operation comprises identifying a sketch feature from a requirement electronic record. For example, a sketch feature may be representative of a feature of a sketch or 3D model. In some embodiments, a sketch-based filtering operation comprises identifying one or more other sketch features from one or more archived project electronic records. In some embodiments, a sketch-based filtering operation comprises comparing the sketch feature with one or more of the one or more other sketch features. In this regard, for example, the cloud-based project operations device 140 may identify an archived project electronic record by finding a match between the sketch feature and the one or more of the one or more other sketch features.

In some embodiments, the set of electronic filtering operations comprises a topology-based filtering operation. In some embodiments, a topology-based filtering operation comprises identifying a topology feature from a requirement electronic record. For example, topology feature may be data representative of a component configuration, architecture indicating connections between several components, and/or an organization of information in an electronic record. In some embodiments, a topology-based filtering operation comprises identifying one or more other topology features from one or more archived project electronic records. In some embodiments, a topology-based filtering operation comprises comparing the topology feature with one or more of the one or more other topology features. In this regard, for example, the cloud-based project operations device 140 may identify an archived project electronic record by finding a match between the topology feature and the one or more of the one or more other topology features.

In some embodiments, the set of electronic filtering operations comprises a color-based filtering operation. In some embodiments, a color-based filtering operation comprises identifying first pixel data from a requirement electronic record. In some embodiments, a color-based filtering operation comprises identifying other pixel data from one or more archived project electronic records. For example, first pixel data and/or other pixel data may be representative of colors, color usage patterns, and/or color coordinates in an electronic record. In some embodiments, a color-based filtering operation comprises comparing the first pixel data with the other pixel data. In this regard, for example, the cloud-based project operations device 140 may identify an archived project electronic record by finding a match between the first pixel data and the other pixel data.

In some embodiments, the first project electronic record generation operation comprises the cloud-based project operations device 140 being configured to generate an archived physical component clone. In some embodiments, the cloud-based project operations device 140 is configured to generate an archived physical component clone based on an archived physical component. For example, an archived physical component clone may be generated based on an archived physical component that is part of an archived project electronic record identified using one or more of the set of electronic filtering operations. In this regard, in some embodiments, an archived physical component clone comprises a configurable data object that corresponds to an archived physical component. Said differently, for example, an archived physical component clone may comprise a data object representative of a component that may be configured in order to be used to satisfy one or more requirement features of a project. In some embodiments, the cloud-based project operations device 140 is configured to generate an archived physical component clone using the project record predictive computing entity 212.

In some embodiments, the first project electronic record generation operation comprises the cloud-based project operations device 140 being configured to generate a physical component object. In some embodiments, the cloud-based project operations device 140 is configured to generate a physical component object by configuring an archived physical component clone based on a requirement electronic record. In some embodiments, configuring an archived physical component clone comprises changing one or more settings and/or configurations of the archived project clone. In this regard, a physical component object may be generated by configuring an archived physical component clone in accordance with a requirement, a criteria, and/or a constraint that must be satisfied in order to implement a project. For example, a physical component object representative of a temperature sensor may be generated by configuring an archived physical component clone such that the temperature sensor can facilitate keeping the temperature of a building within a particular range set forth in a requirement feature associated with a proposed project (e.g., a project that has not yet been implemented). In some embodiments, the cloud-based project operations device 140 is configured to generate a physical component object using the project record predictive computing entity 212.

In some embodiments, the first project electronic record generation operation comprises the cloud-based project operations device 140 being configured to generate a project electronic record based on the physical component object generated by configuring an archived physical component clone. In this regard, in some embodiments, the cloud-based project operations device 140 is configured to generate a project electronic record by performing the first project electronic record generation operation in order to generate at least one of the physical component objects in the project electronic record based on an archived physical component object.

In some embodiments, the set of project electronic record generation operations comprises a second project electronic record generation operation. In some embodiments, the second project electronic record generation operation is performed in order to generate project electronic record based on a set of free resource unit objects associated with the cloud-based project operations device 140. In this regard, in some embodiments, the second project electronic record generation operation comprises the cloud-based project operations device 140 being configured to generate a responsive resource allocation unit by applying a requirement feature to a project implementation model. For example, the cloud-based project operations device 140 may be configured to generate a responsive resource allocation unit using the project operations predictive computing entity 220. In some embodiments, a responsive resource allocation unit comprises one or more items of data representative of a physical component object representative of a physical component that satisfies a requirement feature associated with a requirement electronic record. Said differently, for example, a responsive resource allocation unit may comprise one or more items of data representative of a physical component object representative of a physical component that may satisfy a requirement, a criteria, and/or a constraint of a requirement associated with a requirement electronic record. Additionally, or alternatively, a responsive resource allocation unit comprises one or more items of data representative of a physical component implementation unit associated with a physical component that satisfies a requirement feature associated with a requirement electronic record accessed by the cloud-based project operations device 140 (e.g., associated with a physical component object represented by a responsive resource allocation unit). Said differently, for example, a responsive resource allocation unit may be representative of physical components and/or resources that are needed to implement a project associated with a requirement electronic record.

In some embodiments, the cloud-based project operations device 140 is configured to generate a responsive resource allocation unit by applying a requirement feature to a project implementation model. In this regard, in some embodiments, generating a responsive resource allocation unit comprises the cloud-based project operations device 140 being configured to, using the project implementation model, determine a physical component object representative of a physical component that satisfies a requirement feature associated with a requirement electronic record accessed by the cloud-based project operations device 140. In some embodiments, the project implementation model is configured to determine a physical component object representative of a physical component that satisfies a requirement feature associated with a requirement electronic record accessed by the cloud-based project operations device 140 by performing at least one electronic filtering operation of a set of electronic filtering operations, such as described above. In this regard, in some embodiments, the cloud-based project operations device 140 is configured to perform at least one electronic filtering operation to identify a physical component object representative of a physical component that satisfies a requirement feature associated with a requirement electronic record accessed by the cloud-based project operations device 140.

In some embodiments, generating a responsive allocation unit comprises the cloud-based project operations device 140 being configured to, using the project implementation model, determine a physical component implementation unit corresponding to a physical component object that satisfies a requirement feature associated with a requirement electronic record accessed by the cloud-based project operations device 140. In this regard, in some embodiments, the project implementation model may be configured to determine the resources needed to design, engineer, test, implement, configure, and/or acquire one or more physical components that have been identified by the project implementation model.

In some embodiments, the second project electronic record generation operation comprises the cloud-based project operations device 140 being configured to extract a set of free resource unit objects from a plurality of resource unit objects. In some embodiments, the cloud-based project operations device 140 may be configured to extract a set of free resource unit objects from a plurality of resource unit objects using the project operations predictive computing entity 220. In some embodiments, a resource unit object (e.g., of a plurality of resource unit objects) comprises one or more items of data representative of one or more physical components that are associated with the cloud-based project operations device 140. For example, a resource unit object may comprise one or more items of data representative of one or more temperature sensors, circuits, HVAC units or any discrete, individual component used to construct a temperature sensor, a circuit, or an HVAC unit that are associated with the cloud-based project operations device 140. Said differently, for example, a resource unit object may comprise one or more items of data representative of one or more physical components associated with cloud-based project operations device 140 that could potentially be used by the cloud-based project operations device 140 to implement a project.

Additionally, or alternatively, a resource unit object (e.g., of a plurality of resource unit objects) comprises one or more items of data representative of one or more physical component implementation units that are associated with the cloud-based project operations device 140. For example, a resource unit object may comprise one or more items of data representative of one or more resources (e.g., temporal resources, logistical resources, geographic resources, and/or implementation resources) needed to design, engineer, test, implement, configure, and/or acquire one or more physical components associated with the cloud-based project operations device 140. Said differently, for example, a resource unit object may comprise one or more items of data representative of one or more resources associated with cloud-based project operations device 140 that could potentially be used by the cloud-based project operations device 140 to implement a physical component associated with the cloud-based project operations device 140.

In some embodiments, a free resource unit object (e.g., of a set of free resource unit objects) comprises one or more items of data representative of one or more resource unit objects that correspond to a responsive resource allocation unit generated by the cloud-based project operations device 140. For example, a free resource unit object may comprise one or more items of data representative of one or more physical component objects that correspond to a responsive resource allocation unit generated by the cloud-based project operations device 140. As another example, a free resource unit object may comprise one or more items of data representative of one or more resources (e.g., temporal resources, logistical resources, geographic resources, and/or implementation resources) needed to design, engineer, test, implement, configure, and/or acquire one or more physical components that correspond to a responsive resource allocation unit generated by the cloud-based project operations device 140. Said differently, a set of free resource unit objects may comprise one or more resource unit objects from a plurality of resource unit objects associated with the cloud-based project operations device that may be used to implement a particular project associated with a particular requirement electronic record accessed by the cloud-based project operations device 140.

In some embodiments, the cloud-based project operations device 140 is configured to extract a set of free resource unit objects from a plurality of resource unit objects based on a responsive resource allocation unit. In this regard, in some embodiments, the cloud-based project operations device 140 is configured to extract a set of free resource unit objects from a plurality of resource unit objects by matching resource unit objects of a plurality of resource unit objects associated with the cloud-based project operations device 140 with a responsive resource allocation unit. For example, the cloud-based project operations device 140 may be configured to extract a free resource unit object representative of a physical component object from a plurality of resource unit objects by matching the free resource unit object with a physical component object represented by a responsive resource allocation unit. As another example, the cloud-based project operations device 140 may configured to extract a free resource unit object representative of a resource from a plurality of resource unit objects by matching the free resource unit object with a resource represented by a responsive resource allocation unit.

In some embodiments, the second project electronic record generation operation comprises the cloud-based project operations device 140 being configured to generate a project electronic record (e.g., using the project operations predictive computing entity 220). For example, the cloud-based project operations device 140 is configured to generate a project electronic record by applying a set of free resource unit objects to the project implementation model. In this regard, in some embodiments, a project electronic record comprises an electronic record that describes a plan, design, and/or process for implementing a project using a set of free resource unit objects. For example, a project electronic record may comprise an electronic record that describes a plan, design, and/or process for implementing a project using one or more physical components associated with a set of free resource unit objects. As another example, a project electronic record may comprise an electronic record that describes a plan, design, and/or process for implementing a project using one or more resources associated with a set of free resource unit objects.

In some embodiments, the project implementation model comprises hardware and/or software that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate a responsive resource allocation unit, generate a project electronic record, determine a physical component object corresponding to a requirement feature, determine a physical component implementation unit based on a physical component object, and/or the like. In this regard, in some embodiments, the project implementation model may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques. In some embodiments, the project implementation model comprises one or more layers. For example, the project implementation model may comprise a first layer configured to generate a responsive resource allocation unit. As another example, the project implementation model may comprise a second layer configured to generate a project electronic record.

In some embodiments, the set of project electronic record generation operations comprises a third project electronic record generation operation. In some embodiments, the second project electronic record generation operation is performed in order to generate a project electronic record based on a new physical component object or a reconfigured physical component object. In this regard, in some embodiments, the third project electronic record generation operation comprises the cloud-based project operations device 140 being configured to retrieve a set of archived physical component objects from an archived physical component database of the one or more databases 150. For example, the cloud-based project operations device 140 may be configured to retrieve a set of archived physical component objects from an archived physical component database using the project component engineering predictive computing entity 214. In some embodiments, archived physical component database is configured to store the set of archived physical component objects.

In some embodiments, an archived physical component object comprises one or more items of data that describes a physical component that was implemented in a completed, previous, and/or archived project. In this regard, in some embodiments, the set of archived physical component objects is representative of a collection of archived physical component objects that are associated with physical components that were constructed and/or implemented in a completed, previous, and/or archived project. For example, an archived physical component object may be representative of a temperature sensor, a circuit, an HVAC unit or any discrete, individual component used to construct a temperature sensor, a circuit, or an HVAC unit. Said differently, for example, an archived physical component object may be representative of an archived physical component that formed a portion of a completed, previous, and/or archived project.

In some embodiments, the third project electronic record generation operation comprises the cloud-based project operations device 140 being configured to generate a physical component requirement indication. For example, the cloud-based project operations device 140 may be configured to generate a physical component requirement indication using the project component engineering predictive computing entity 214. In some embodiments, the cloud-based project operations device 140 is configured to generate a physical component requirement indication based on a requirement electronic record and/or at least one of a set of archived physical component objects. In some embodiments, a physical component requirement indication comprises a physical component generation indicator. Additionally, or alternatively, a physical component requirement indication comprises a physical component reconfiguration indicator. Said differently, for example, a physical component requirement indication may be a physical component generation indicator or a physical component reconfiguration indicator.

In some embodiments, a physical component generation indicator comprises one or more items of data that indicates that the set of archived physical component objects does not include an archived physical component object that may be used to satisfy a requirement feature associated with a requirement electronic record. In this regard, for example, a physical component generation indicator may indicate that the set of archived physical component objects does not include an archived physical component object that satisfies a requirement, a criteria, and/or a constraint associated with a physical component to be used in a proposed project that must be satisfied in order to implement a project (e.g., a proposed project). For example, a physical component generation indicator may indicate that the set of archived physical component objects does not include an archived physical component object representative of an HVAC unit having a volume that is within a particular range of acceptable volumes. Said differently, for example, a physical component generation indicator may indicate that the set of archived physical component objects does not include an archived physical component that describes a completed, previous, and/or archived physical component that may be used to satisfy a requirement feature associated with a requirement electronic record.

In some embodiments, the cloud-based project operations device 140 is configured to generate a physical component generation indicator based on a requirement electronic record and/or at least one of a set of archived physical component objects (e.g., using the project component engineering predictive computing entity 214). For example, the cloud-based project operations device 140 may be configured to generate a physical component generation indicator by applying a requirement electronic record and/or at least one of a set of archived physical component objects to a component differentiation model. In this regard, in some embodiments, the component differentiation model may be configured to generate a physical component generation indicator by comparing a requirement electronic record and at least one of a set of archived physical component objects.

In some embodiments, the third project electronic record generation operation comprises the cloud-based project operations device 140 being configured to generate a new physical component object. For example, the cloud-based project operations device 140 may be configured to generate a new physical component object using the project component engineering predictive computing entity 214. In some embodiments, the cloud-based project operations device 140 is configured to generate a new physical component object in response to generating a physical component generation indicator. In this regard, in some embodiments, the cloud-based project operations device 140 is configured to generate a new physical component object based on a physical component generation indicator.

In some embodiments, a new physical component object comprises one or more items of data that describes a physical component that may be implemented in a proposed project associated with a requirement electronic record and does not correspond to a physical component associated with at least one of the set of archived physical component objects (e.g., a new physical component object is associated with a new physical component). In this regard, in some embodiments, a new physical component object may describe a physical component that satisfies a requirement feature associated with a requirement electronic record. For example, a new physical component object may describe an HVAC unit having a volume that is within a particular range of acceptable volumes. In some embodiments, the new physical component object comprises a 3-dimensional virtual model that depicts a physical component that may be implemented in a proposed project associated with a requirement electronic record.

In some embodiments, a physical component reconfiguration indicator comprises one or more items of data that indicates that the set of archived physical component objects includes an archived physical component object representative of a physical component that may be reconfigured such that it may be used to satisfy a requirement feature associated with a requirement electronic record. In this regard, for example, a physical component reconfiguration indicator may indicate that the set of archived physical component objects includes an archived physical component object representative of a physical component that may be reconfigured to satisfy a requirement, a criteria, and/or a constraint associated with a physical component to be used in a proposed project that must be satisfied in order to implement a proposed project. For example, a physical component reconfiguration indicator may indicate that the set of archived physical component objects includes an archived physical component object representative of a circuit board having a surface area that may be reconfigured (e.g., made smaller). Said differently, for example, a physical component reconfiguration indicator may indicate that the set of archived physical component objects includes an archived physical component that describes a completed, previous, and/or archived physical component that may be reconfigured such that it that may be used to satisfy a requirement feature associated with a requirement electronic record.

In some embodiments, the cloud-based project operations device 140 is configured to generate a physical component reconfiguration indicator based on a requirement electronic record and/or at least one of a set of archived physical component objects (e.g., using the project component engineering predictive computing entity 214). For example, the cloud-based project operations device 140 may be configured to generate a physical component reconfiguration indicator by applying a requirement electronic record and/or at least one of a set of archived physical component objects to a component differentiation model. In this regard, in some embodiments, the component differentiation model may be configured to generate a physical component reconfiguration indicator by comparing a requirement electronic record and at least one of a set of archived physical component objects.

In some embodiments, the component differentiation model may comprise hardware and/or software that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate physical component requirement indications. In this regard, in some embodiments, the component differentiation model may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques.

In some embodiments, the third project electronic record generation operation comprises the cloud-based project operations device 140 being configured to generate a reconfigured physical component object. For example, the cloud-based project operations device 140 may be configured to generate a reconfigured physical component object using the project component engineering predictive computing entity 214. In some embodiments, the cloud-based project operations device 140 is configured to generate a reconfigured physical component object in response to generating a physical component reconfiguration indicator. In this regard, in some embodiments, the cloud-based project operations device 140 is configured to generate a reconfigured physical component object based on a physical component reconfiguration indicator.

In some embodiments, a reconfigured physical component object comprises one or more items of data that describes a physical component that may be implemented in a proposed project associated with a requirement electronic record and corresponds to a physical component associated with at least one of the set of archived physical component objects (e.g., a reconfigured physical component object is associated with a reconfigured version of a physical component associated with at least one of the set of archived physical component objects). In this regard, in some embodiments, a reconfigured physical component object may describe a physical component that satisfies a requirement feature associated with a requirement electronic record. For example, a reconfigured physical component object may describe an HVAC unit that has been reconfigured to have a volume that is within a particular range of acceptable volumes. In some embodiments, the reconfigured physical component object comprises a 3-dimensional virtual model that depicts a physical component that may be implemented in a proposed project associated with a requirement electronic record.

In some embodiments, the third project electronic record generation operation comprises the cloud-based project operations device 140 being configured to generate a project electronic record. In some embodiments, the cloud-based project operations device 140 is configured to generate a project electronic record based on a new physical component object. In this regard, in some embodiments, a project electronic record generated based on a new physical component object comprises the new physical component object. In some embodiments, the cloud-based project operations device 140 is configured to generate a project electronic record based on a reconfigured physical component object. In this regard, in some embodiments, a project electronic record generated based on a reconfigured physical component object comprises the reconfigured physical component object.

In some embodiments, the cloud-based project operations device 140 is configured to perform a project configuration check operation. In some embodiments, a project configuration check operation comprises the cloud-based project operations device 140 being configured to generate a project configuration check interface component 502. In some embodiments, the project configuration check interface component 502 comprises a physical component object representation 504. In some embodiments, a physical component object representation 504 is a visual representation of one or more physical component objects associated with a project electronic record. For example, the physical component object representation 504 may comprise color, text (e.g., natural language), visual indicators, and/or the like that provide information about one or more physical component objects associated with a project electronic record.

In some embodiments, a project configuration check operation comprises the cloud-based project operations device 140 being configured to cause the project configuration check interface component 502 to be rendered to the project operations interface 400. For example, the project operations interface 400 may be provided on the project foundation device 180 and/or the cloud-based project operations device 140.

In some embodiments, a project configuration check operation comprises the cloud-based project operations device 140 being configured to receive a first reconfiguration feature corresponding to a physical component object via the project configuration check interface component 502. In some embodiments, a first reconfiguration feature comprises one or more items of data representative of a change to a physical component object represented by the physical component object representation 504. For example, if the physical component object representation 504 is indicative of a temperature sensor to be used in a project associated with a project electronic record, a first reconfiguration feature may be representative of a change in type of the temperature sensor to be used in a project associated with a project electronic record. Said differently, for example, a first reconfiguration feature may a change to a particular physical component object that is to be used in a project associated with a project electronic record.

In some embodiments, a project configuration check operation comprises the cloud-based project operations device 140 being configured to update a physical component object based on a first reconfiguration feature. In this regard, in some embodiments, based on a change indicated by a first reconfiguration feature, the cloud-based project operations device 140 may be configured to change a project electronic record by updating a physical component object associated with the project electronic record. Said differently, for example, the project configuration check interface component 502 may be configured such that one or more updates can be made to physical component objects associated with a project electronic record before a project associated with the project electronic record is implemented.

In some embodiments, the project configuration check interface component 502 comprises a physical component implementation unit representation 506. In some embodiments, a physical component implementation unit representation 506 is a visual representation of one or more physical component implementation units associated with a project electronic record. For example, the physical component implementation unit representation 506 may comprise color, text (e.g., natural language), visual indicators, and/or the like that provide information about one or more physical component implementation units associated with a project electronic record.

In some embodiments, a project configuration check operation comprises the cloud-based project operations device 140 being configured to receive a second reconfiguration feature corresponding to a physical component implementation unit via the project configuration check interface component 502. In some embodiments, a second reconfiguration feature comprises one or more items of data representative of a change to a physical component implementation unit represented by the physical component implementation unit representation 506. For example, if the physical component implementation unit representation 506 is indicative of a temporal resource to be used in a project associated with a project electronic record, a second reconfiguration feature may be representative of a change to the temporal resource associated with a project associated with a project electronic record. Said differently, for example, a second reconfiguration feature may a change to a particular physical component implementation unit that is to be used in a project associated with a project electronic record.

In some embodiments, a project configuration check operation comprises the cloud-based project operations device 140 being configured to update a physical component implementation unit based on a second reconfiguration feature. In this regard, in some embodiments, based on a change indicated by a second reconfiguration feature, the cloud-based project operations device 140 may be configured to change a project electronic record by updating a physical component implementation unit associated with the project electronic record. Said differently, for example, the project configuration check interface component 502 may be configured such that one or more updates can be made to physical component implementation units associated with a project electronic record before a project associated with the project electronic record is implemented.

In some embodiments, the cloud-based project operations device 140 is configured to perform one or more project responsive actions. In some embodiments, the cloud-based project operations device 140 is configured to perform one or more project responsive actions based on one or more project electronic records. In this regard, in some embodiments, performing one or more project responsive actions comprises the project record predictive computing entity 212 being configured to generate a project electronic record interface component 602. In some embodiments, the project electronic record interface component 602 comprises a project electronic record interface element 604 configured to display a visual representation of one or more project electronic records.

In some embodiments, performing one or more project responsive actions includes the cloud-based project operations device 140 being configured to cause the project electronic record interface component 602 to be rendered to a project operations interface 400. In some embodiments, the project operations interface 400 may be provided on a display associated with the cloud-based project operations device 140 and/or a display associated with the project foundation device 180.

In some embodiments, performing one or more project responsive actions comprises the cloud-based project operations device 140 being configured to generate a preliminary success rate prediction. For example, the cloud-based project operations device 140 may be configured to generate a preliminary success rate prediction based on an analysis of a first set of similar historical projects (e.g., archived projects). In some embodiments, performing one or more project responsive actions comprises the cloud-based project operations device 140 being configured to generate an updated success rate prediction. For example, the cloud-based project operations device 140 may be configured to generate an updated success rate prediction based on an analysis of a second set of similar historical projects (e.g., archived projects). In some embodiments, performing one or more project responsive actions comprises the cloud-based project operations device 140 being configured to update one or more project estimations based on the automated mitigation action and the at least one non-compliant dependency.

In some embodiments, performing one or more project responsive actions includes the cloud-based project operations device 140 being configured to cause a component inventory record to be updated. In some embodiments, a component inventory record is a record that indicates one or more physical components that may be included in a project associated with a project electronic record. In this regard, for example, a component inventory record may be updated to be associated with an indication that a physical component is necessary for the manufacturing of a physical component associated with a project electronic record. As another example, a component inventory record may be updated to cause, by cloud-based project operations device 140 via inventory predictive computing entity 206, procurement of a physical component. In this regard, in some embodiments, perform one or more project responsive actions may comprise causing one or more manufacturing systems to operate in order to generate a physical component. Additionally, or alternatively, perform one or more project responsive actions may comprise causing one or more systems to shut down (e.g., after the physical component has been generated).

### EXAMPLE METHODS

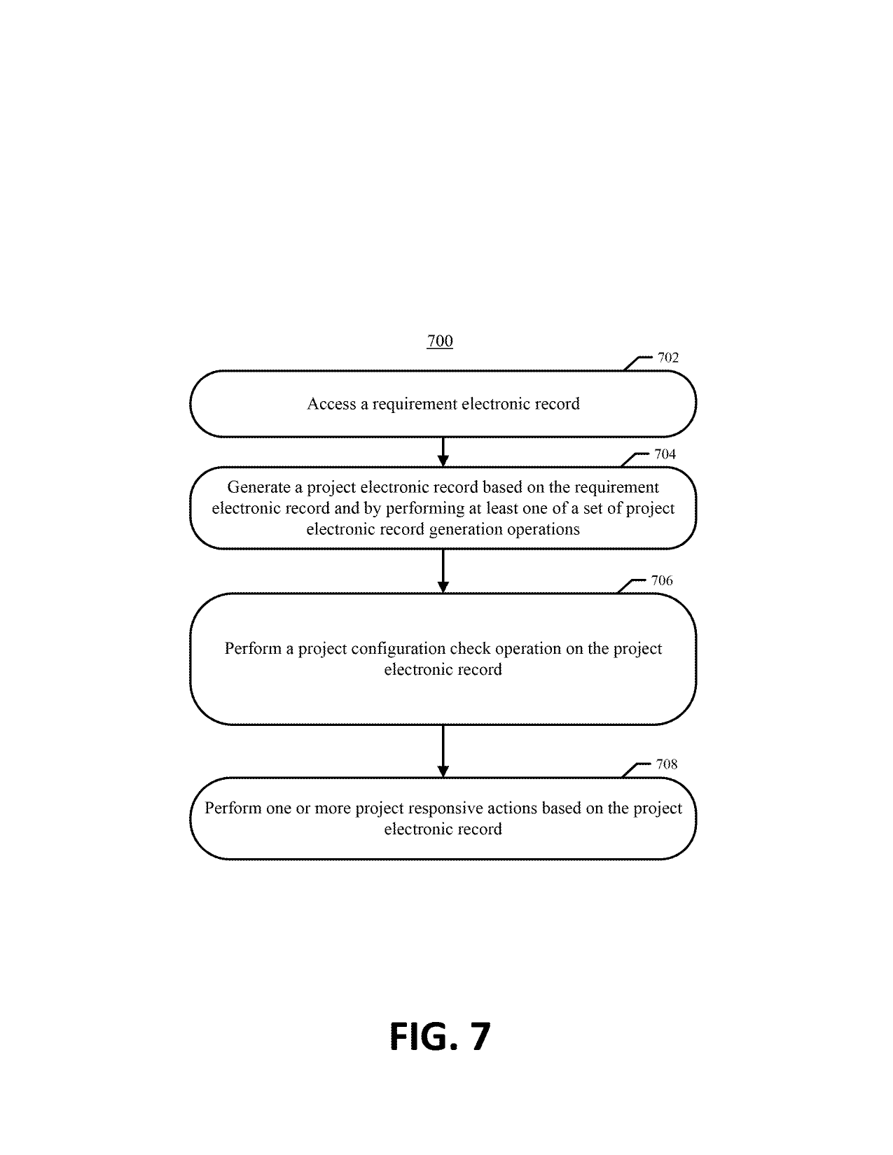

Referring now to FIG. 7, a flowchart providing an example method 700 is illustrated. In this regard, FIG. 7 illustrates operations that may be performed by the project foundation device 180, the external project implementation device 120, the external project application device 110, the cloud-based project operations device 140, the one or more databases 150, and/or the user device 170. In some embodiments, the method 700 comprises operations for generating a project electronic record. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 may comprise accessing a requirement electronic record. As described above, in some embodiments, a requirement electronic record comprises an electronic record that is representative of one or more requirement features (e.g., a requirement electronic record comprises one or more electronic records). In this regard, in some embodiments, a requirement electronic record may be one or more of a text document, a schematic drawing, a 3D model, a computer-aided design (CAD) file, an image, a video, and/or the like. For example, a requirement electronic record may be a schematic drawing that depicts one or more requirement features. As another example, a requirement electronic record may be a video that depicts one or more requirement features. As another example, a requirement electronic recordmay be a text document that describes one or more requirement features. As another example, a requirement electronic recordmay be a 3D model that depicts one or more requirement features. As another example, requirement electronic record may be a computer-aided design (CAD) file that describes and/or depicts one or more requirement features. As another example, requirement electronic record may be an image that depicts one or more requirement features.

In some embodiments, a requirement feature comprises one or more items of data representative of a requirement, a criteria, and/or a constraint that must be satisfied in order to implement a project (e.g., a proposed project that has not yet been implemented). For example, a requirement feature may be one or more items of data that are representative of a requirement, a criteria, and/or a constraint that must be satisfied in order to implement a project that includes controlling the temperature of a building. In this regard, for example, a requirement feature may be representative of a particular range in which the temperature of a building must be controlled to stay within (e.g., a requirement). As another example, a requirement feature may be representative of a physical layout of a building in which the temperature is to be controlled (e.g., a constraint). As another example, a requirement feature may be representative of an implementation time for a project (e.g., how long it may take to implement a project, when a project must be implemented, etc.). As another example, a requirement feature may be representative of a geographic location associated with a project (e.g., where a project should be implemented, a restriction on where resources for project should be obtained from, etc.).

In some embodiments, accessing a requirement electronic record comprises the cloud-based project operations device 140 being configured to retrieve a requirement electronic record. For example, the cloud-based project operations device 140 may be configured to retrieve a requirement electronic record from the one or more databases 150 using the project orchestration predictive computing entity 204. As another example, cloud-based project operations device 140 may be configured to retrieve a requirement electronic record from the internal databases 224 using the project orchestration predictive computing entity 204. In some embodiments, accessing a requirement electronic record comprises the cloud-based project operations device 140 being configured to receive a requirement electronic record. For example, the cloud-based project operations device 140 may be configured to receive a requirement electronic record from the project foundation device 180. As another example, the cloud-based project operations device 140 may be configured to receive a requirement electronic record from the external project application device 110. In some embodiments, prior to the cloud-based project operations device 140 accessing a requirement electronic record at the project orchestration predictive computing entity 204, a requirement electronic record may be processed by the project operations security layer 202 using one or more cybersecurity operations. In some embodiments, accessing a requirement electronic record comprises the cloud-based project operations device 140 providing access to a requirement electronic record to project operations predictive computing entity 220 via project orchestration predictive computing entity 204.

In some embodiments, accessing a requirement electronic record comprises the cloud-based project operations device 140 being configured to generate a requirement electronic record. In some embodiments, a requirement electronic record is generated based on a requirement electronic record generation operation. For example, a requirement electronic record generation operation may be performed using the project orchestration predictive computing entity 204. In this regard, in some embodiments, a requirement electronic record generation operation comprises the cloud-based project operations device 140 being configured to receive one or more requirement features associated with a project. For example, the cloud-based project operations device 140 may be configured to receive one or more requirement features associated with a project from the project foundation device 180. In some embodiments, the one or more requirement features may be received by the cloud-based project operations data in the form of project metadata from which the cloud-based project operations device 140 is configured to extract the one or more requirement features.

As shown in block 704, the method 700 may comprise generating a project electronic record based on the requirement electronic record and by performing at least one of a set of project electronic record generation operations. As described above, in some embodiments, a project electronic record comprises an electronic record that describes a plan, design, and/or process for implementing project corresponding to a requirement electronic record. In this regard, for example, a project electronic record may be representative of a collection of one or more physical component objects that may be used for implementing a project in accordance with a requirement electronic record. For example, a project electronic record may comprise a collection of physical component objects that are representative of temperature sensors, temperature control systems, circuits, and/or heating, ventilation, and air conditioning (HVAC) units that have been configured to control the temperature of a building based on one or more requirement features set forth in a requirement electronic record. In some embodiments, the cloud-based project operations device 140 is configured to generate a project electronic record using the project record predictive computing entity 212. Additionally, or alternatively, a project electronic record may be representative of a collection of one or more physical component implementation units that are associated with a project associated with the project electronic record. For example, a project electronic record may comprise one or more items of data representative of one or more resources (e.g., temporal resources, logistical resources, geographic resources, and/or implementation resources) needed to design, engineer, test, implement, configure, and/or acquire one or more physical components that are associated with a project associated with the project electronic record. Said differently, for example, a project electronic record may comprise one or more items of data representative of one or more resources that could potentially be used by the cloud-based project operations device 140 to implement a physical component in a project associated with a project electronic record.

In some embodiments, the cloud-based project operations device 140 is configured to generate a project electronic record based on a requirement electronic record and/or by performing at least one of a set of project electronic record generation operations. In this regard, in some embodiments, the set of project electronic record generation operations may comprise a collection of project electronic record generation operations that may be performed in order to generate various portions of a project electronic record based on various different constraints associated with a particular project (e.g., a proposed project) and/or the cloud-based project operations device 140.

As shown in block 706, the method 700 may comprise performing a project configuration check operation on the project electronic record. As described above, in some embodiments, a project configuration check operation comprises the cloud-based project operations device 140 being configured to generate a project configuration check interface component 502. In some embodiments, the project configuration check interface component 502 comprises a physical component object representation 504. In some embodiments, a physical component object representation 504 is a visual representation of one or more physical component objects associated with a project electronic record. For example, the physical component object representation 504 may comprise color, text (e.g., natural language), visual indicators, and/or the like that provide information about one or more physical component objects associated with a project electronic record.

In some embodiments, a project configuration check operation comprises the cloud-based project operations device 140 being configured to cause the project configuration check interface component 502 to be rendered to the project operations interface 400. For example, the project operations interface 400 may be provided on the project foundation device 180 and/or the cloud-based project operations device 140.

In some embodiments, a project configuration check operation comprises the cloud-based project operations device 140 being configured to receive a first reconfiguration feature corresponding to a physical component object via the project configuration check interface component 502. In some embodiments, a first reconfiguration feature comprises one or more items of data representative of a change to a physical component object represented by the physical component object representation 504. For example, if the physical component object representation 504 is indicative of a temperature sensor to be used in a project associated with a project electronic record, a first reconfiguration feature may be representative of a change in type of the temperature sensor to be used in a project associated with a project electronic record. Said differently, for example, a first reconfiguration feature may a change to a particular physical component object that is to be used in a project associated with a project electronic record.

In some embodiments, a project configuration check operation comprises the cloud-based project operations device 140 being configured to update a physical component object based on a first reconfiguration feature. In this regard, in some embodiments, based on a change indicated by a first reconfiguration feature, the cloud-based project operations device 140 may be configured to change a project electronic record by updating a physical component object associated with the project electronic record. Said differently, for example, the project configuration check interface component 502 may be configured such that one or more updates can be made to physical component objects associated with a project electronic record before a project associated with the project electronic record is implemented.

In some embodiments, the project configuration check interface component 502 comprises a physical component implementation unit representation 506. In some embodiments, a physical component implementation unit representation 506 is a visual representation of one or more physical component implementation units associated with a project electronic record. For example, the physical component implementation unit representation 506 may comprise color, text (e.g., natural language), visual indicators, and/or the like that provide information about one or more physical component implementation units associated with a project electronic record.

In some embodiments, a project configuration check operation comprises the cloud-based project operations device 140 being configured to receive a second reconfiguration feature corresponding to a physical component implementation unit via the project configuration check interface component 502. In some embodiments, a second reconfiguration feature comprises one or more items of data representative of a change to a physical component implementation unit represented by the physical component implementation unit representation 506. For example, if the physical component implementation unit representation 506 is indicative of a temporal resource to be used in a project associated with a project electronic record, a second reconfiguration feature may be representative of a change to the temporal resource associated with a project associated with a project electronic record. Said differently, for example, a second reconfiguration feature may a change to a particular physical component implementation unit that is to be used in a project associated with a project electronic record.

In some embodiments, a project configuration check operation comprises the cloud-based project operations device 140 being configured to update a physical component implementation unit based on a second reconfiguration feature. In this regard, in some embodiments, based on a change indicated by a second reconfiguration feature, the cloud-based project operations device 140 may be configured to change a project electronic record by updating a physical component implementation unit associated with the project electronic record. Said differently, for example, the project configuration check interface component 502 may be configured such that one or more updates can be made to physical component implementation units associated with a project electronic record before a project associated with the project electronic record is implemented.

As shown in block 708, the method 700 may comprise performing one or more project responsive actions based on the project electronic record. As described above, in some embodiments, the cloud-based project operations device 140 is configured to perform one or more project responsive actions based on one or more project electronic records. In this regard, in some embodiments, performing one or more project responsive actions comprises the project record predictive computing entity 212 being configured to generate a project electronic record interface component 602. In some embodiments, the project electronic record interface component 602 comprises a project electronic record interface element 604 configured to display a visual representation of one or more project electronic records.

In some embodiments, performing one or more project responsive actions includes the cloud-based project operations device 140 being configured to cause the project electronic record interface component 602 to be rendered to a project operations interface 400. In some embodiments, the project operations interface 400 may be provided on a display associated with the cloud-based project operations device 140 and/or a display associated with the project foundation device 180.

In some embodiments, performing one or more project responsive actions comprises the cloud-based project operations device 140 being configured to generate a preliminary success rate prediction. For example, the cloud-based project operations device 140 may be configured to generate a preliminary success rate prediction based on an analysis of a first set of similar historical projects (e.g., archived projects). In some embodiments, performing one or more project responsive actions comprises the cloud-based project operations device 140 being configured to generate an updated success rate prediction. For example, the cloud-based project operations device 140 may be configured to generate an updated success rate prediction based on an analysis of a second set of similar historical projects (e.g., archived projects). In some embodiments, performing one or more project responsive actions comprises the cloud-based project operations device 140 being configured to update one or more project estimations based on the automated mitigation action and the at least one non-compliant dependency.

In some embodiments, performing one or more project responsive actions includes the cloud-based project operations device 140 being configured to cause a component inventory record to be updated. In some embodiments, a component inventory record is a record that indicates one or more physical components that may be included in a project associated with a project electronic record. In this regard, for example, a component inventory record may be updated to be associated with an indication that a physical component is necessary for the manufacturing of a physical component associated with a project electronic record. As another example, a component inventory record may be updated to cause, by cloud-based project operations device 140 via inventory predictive computing entity 206, procurement of a physical component. In this regard, in some embodiments, perform one or more project responsive actions may comprise causing one or more manufacturing systems to operate in order to generate a physical component. Additionally, or alternatively, perform one or more project responsive actions may comprise causing one or more systems to shut down (e.g., after the physical component has been generated).

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
accessing, at a project orchestration predictive computing entity, a requirement electronic record, wherein the requirement electronic record comprises a requirement feature, wherein the requirement electronic record is generated based on a requirement electronic record generation operation;
generating, using a project record predictive computing entity, a project electronic record based on the requirement electronic record and by performing at least one of a set of project electronic record generation operations;
performing, using the project orchestration predictive computing entity, a project configuration check operation on the project electronic record; and
performing, using the project orchestration predictive computing entity, one or more project responsive actions based on the project electronic record.

2. The method of claim 1, wherein the requirement electronic record generation operation comprises:
receiving one or more requirement features associated with a project;
identifying a first requirement feature of the one or more requirement features associated with the project;
generating an inferred requirements interface component comprising one or more prompts corresponding to a responsive feature associated with the first requirement feature;
causing the inferred requirements interface component to be rendered to a project operations interface;
receiving the responsive feature associated with the first requirement feature via the inferred requirements interface component;
updating the first requirement feature based on the responsive feature; and
generating the requirement electronic record based on at least the first requirement feature.

3. The method of claim 1, wherein a first project electronic record generation operation of the set of project electronic record generation operations comprises:
identifying an archived project electronic record by performing at least one electronic filtering operation of a set of electronic filtering operations, wherein the archived project electronic record is representative of an archived physical component corresponding to the requirement feature;
generating an archived physical component clone based on the archived physical component;
generating a physical component object by configuring the archived physical component clone based on the requirement electronic record; and
generating the project electronic record based on the physical component object.

4. The method of claim 3, wherein the set of electronic filtering operations comprises a text-based filtering operation, geometry-based filtering operation, design-based filtering operation, sketch-based filtering operation, topology-based filtering operation, or color-based filtering operation.

5. The method of claim 1, wherein a second project electronic record generation operation of the set of project electronic record generation operations comprises:
generating a responsive resource allocation unit by applying the requirement feature to a project implementation model;
extracting a set of free resource unit objects from a plurality of resource unit objects based on the responsive resource allocation unit; and
generating a project electronic record by applying the set of free resource unit objects to the project implementation model.

6. The method of claim 5, wherein generating the responsive resource allocation unit comprises:
determining, using the project implementation model, a physical component object corresponding to the requirement feature; and
determining, using the project implementation model, a physical component implementation unit based on the physical component object.

7. The method of claim 1, wherein a third project electronic record generation operation of the set of project electronic record generation operations comprises:
retrieving a set of archived physical component objects from an archived physical component database;
generating a physical component requirement indication by applying the requirement electronic record and the set of archived physical component objects to a component differentiation model, wherein the physical component requirement indication comprises a physical component generation indicator or a physical component reconfiguration indicator;
generating a new physical component object based on the physical component generation indicator or generating a reconfigured physical component object based on the physical component reconfiguration indicator; and
generating the project electronic record based on the new physical component object or the reconfigured physical component object.

8. The method of claim 1, wherein the project electronic record comprises a physical component object and a physical component implementation unit, wherein performing the project configuration check operation comprises:
generating a project configuration check interface component, wherein the project configuration check interface component comprises a physical component object representation corresponding to the physical component object or a physical component implementation unit representation corresponding to the physical component implementation unit;
causing the project configuration check interface component to be rendered to a project operations interface;
receiving a first reconfiguration feature corresponding to the physical component object via the project configuration check interface component or a second reconfiguration feature corresponding to the physical component implementation unit via the project configuration check interface component; and
updating the physical component object based on the first reconfiguration feature or the physical component implementation unit based on the second reconfiguration feature.

9. The method of claim 1, wherein performing the one or more project responsive actions comprises:
generating a project electronic record interface component, wherein the project electronic record interface component comprises project electronic record interface element; and
causing rendering of the project electronic record interface component via a project operations interface.

10. The method of claim 1, wherein performing the one or more project responsive actions comprises:
causing a component inventory record to be updated.

11. An apparatus comprising memory and one or more processors communicatively coupled to the memory, the one or more processors configured to perform operations comprising:
accessing, at a project orchestration predictive computing entity, a requirement electronic record, wherein the requirement electronic record comprises a requirement feature, wherein the requirement electronic record is generated based on a requirement electronic record generation operation;
generating, using a project record predictive computing entity, a project electronic record based on the requirement electronic record and by performing at least one of a set of project electronic record generation operations;
performing, using the project orchestration predictive computing entity, a project configuration check operation on the project electronic record; and
performing, using the project orchestration predictive computing entity, one or more project responsive actions based on the project electronic record.

12. The apparatus of claim 11, wherein the requirement electronic record generation operation comprises:
receiving one or more requirement features associated with a project;
identifying a first requirement feature of the one or more requirement features associated with the project;
generating an inferred requirements interface component comprising one or more prompts corresponding to a responsive feature associated with the first requirement feature;
causing the inferred requirements interface component to be rendered to a project operations interface;
receiving the responsive feature associated with the first requirement feature via the inferred requirements interface component;
updating the first requirement feature based on the responsive feature; and
generating the requirement electronic record based on at least the first requirement feature.

13. The apparatus of claim 11, wherein a first project electronic record generation operation of the set of project electronic record generation operations comprises:
identifying an archived project electronic record by performing at least one electronic filtering operation of a set of electronic filtering operations, wherein the archived project electronic record is representative of an archived physical component corresponding to the requirement feature;
generating an archived physical component clone based on the archived physical component;
generating a physical component object by configuring the archived physical component clone based on the requirement electronic record; and
generating the project electronic record based on the physical component object.

14. The apparatus of claim 13, wherein the set of electronic filtering operations comprises a text-based filtering operation, geometry-based filtering operation, design-based filtering operation, sketch-based filtering operation, topology-based filtering operation, or color-based filtering operation.

15. The apparatus of claim 11, wherein a second project electronic record generation operation of the set of project electronic record generation operations comprises:
generating a responsive resource allocation unit by applying the requirement feature to a project implementation model;
extracting a set of free resource unit objects from a plurality of resource unit objects based on the responsive resource allocation unit; and
generating a project electronic record by applying the set of free resource unit objects to the project implementation model.

16. The apparatus of claim 15, wherein generating the responsive resource allocation unit comprises:
determining, using the project implementation model, a physical component object corresponding to the requirement feature; and
determining, using the project implementation model, a physical component implementation unit based on the physical component object.

17. The apparatus of claim 11, wherein a third project electronic record generation operation of the set of project electronic record generation operations comprises:
retrieving a set of archived physical component objects from an archived physical component database;
generating a physical component requirement indication by applying the requirement electronic record and the set of archived physical component objects to a component differentiation model, wherein the physical component requirement indication comprises a physical component generation indicator or a physical component reconfiguration indicator;
generating a new physical component object based on the physical component generation indicator or generating a reconfigured physical component object based on the physical component reconfiguration indicator; and
generating the project electronic record based on the new physical component object or the reconfigured physical component object.

18. The apparatus of claim 11, wherein the project electronic record comprises a physical component object and a physical component implementation unit, wherein performing the project configuration check operation comprises:
generating a project configuration check interface component, wherein the project configuration check interface component comprises a physical component object representation corresponding to the physical component object or a physical component implementation unit representation corresponding to the physical component implementation unit;
causing the project configuration check interface component to be rendered to a project operations interface;
receiving a first reconfiguration feature corresponding to the physical component object via the project configuration check interface component or a second reconfiguration feature corresponding to the physical component implementation unit via the project configuration check interface component; and
updating the physical component object based on the first reconfiguration feature or the physical component implementation unit based on the second reconfiguration feature.

19. The apparatus of claim 11, wherein performing the one or more project responsive actions comprises:
generating a project electronic record interface component, wherein the project electronic record interface component comprises project electronic record interface element; and
causing rendering of the project electronic record interface component via a project operations interface.

20. A computer program product comprising at least one non-transitory computer-readable storage medium having computer program code stored thereon that, in execution with at least one processor, configures the computer program product for:
accessing, at a project orchestration predictive computing entity, a requirement electronic record, wherein the requirement electronic record comprises a requirement feature, wherein the requirement electronic record is generated based on a requirement electronic record generation operation;
generating, using a project record predictive computing entity, a project electronic record based on the requirement electronic record and by performing at least one of a set of project electronic record generation operations;
performing, using the project orchestration predictive computing entity, a project configuration check operation on the project electronic record; and
performing, using the project orchestration predictive computing entity, one or more project responsive actions based on the project electronic record.
